(19) United States
(12) Patent Application Publication
(10) Pub. No.: US 2026/0307282 A1
(43) Pub. Date: Oct. 8, 2026

(54) DEVICES AND METHODS FOR SMART PERSONAL GROOMING

(71) Applicant: The Gillette Company LLC, Boston, MA (US)

(72) Inventors: Aditya Milind DESHPANDE, Cincinnati, OH (US); Faiz Feisal SHERMAN, Mason, OH (US); Christian NEYER, Eschborn (DE); Gökçem GÖKMEN, Frankfurt (DE); Stefan FUERST, Eschborn (DE); Thomas VERSTEGE, Frankfurt (DE)

(21) Appl. No.: 19/637,022

(22) Filed: Apr. 2, 2026

Related U.S. Application Data
(60) Provisional application No. 63/782,073, filed on Apr. 2, 2025.

(51) Int. Cl. B26B 19/38

(52) U.S. Cl. CPC B26B 19/388; B26B 19/382

(57) ABSTRACT

A smart personal grooming device or otherwise cutting device comprises a body with a handle, a head portion, a hair cutting implement, a sensor and a camera oriented toward the hair cutting implement. The camera captures images of a skin area and a hair area of a user and a processor detects, based the images and the sensor data, each of the skin area and the hair area. A boundary is defined between the skin area and the hair area. The processor determines a control state based on the boundary that causes the processor to implement one or more algorithms controlling an operating or feature of the smart personal grooming device or otherwise cutting device, including, for example, activating the cutting implement to cause the cutting implement to remove hair in a hair area of the user.

### FIELD

The present disclosure generally relates to grooming devices and methods, and more particularly to, devices and methods for smart personal grooming.

### BACKGROUND

Users typically experience difficulty guiding or handling shaving devices in precise manners to trim or otherwise cut their own hair. This problem can be particularly acute for areas difficult to reach or see, such as the user's face or otherwise an area that requires the user to shave by use of a mirror or other indirect vision. For these reasons, precise shaving or hair removal requires manual assistance of another person. For example, an individual with facial hair can visit a barber for assistance with cutting or trimming hair. After a few days, however, the facial hair begins to regrow (e.g., have hair stubble), and the user cannot readily maintain a style or cut himself or herself as previously provided by a barber.

Conventional trimming devices do not assist users, who have facial hair (or other difficult to address hair areas), to trim or cut such hair. An individual typically requires ad hoc tools like beard stencils over the face while shaving to maintain facial hair styles by themselves, which typically results in imprecise styles or cuts, or can also result in damage to user's skin from lacerations caused by a blade or trimmer, pulled hair, or other skin damage provided by manual attempts at precise cutting or trimming.

In addition, previously known methods for hair style maintenance rely on shaping tools or chemical markers (e.g., dyes) for defining the hair style edges in addition to manual cutting using a manual instrument for cutting the hair and/or stubble. However, the use of these manual tools and/or chemicals makes the process of self-style maintenance difficult.

For the foregoing reasons, there is a need for devices and methods for smart personal grooming.

### SUMMARY

In various aspects herein, smart personal grooming devices and methods are described to address imprecise trimming or cutting, and/or to otherwise enhance user shaving. Such precision is achieved through image acquisition and image analysis captured while the user is shaving with a smart personal grooming or cutting device. Such a smart shaving device, also referred to herein as an “AutoEdger device,” can determine how or when to cut or trim hair based on image acquisition and analysis. The AutoEdger device provides a digital and image-based solution to enhance hair cutting and trimming, with the increased safety of using such a device having a sharp blade. The AutoEdger device also provides a standalone solution that can perform precise trimming and/or cutting itself by using a sensor to control a trimmer or blade.

Generally, the AutoEdger device comprises a hair trimmer or cutter with a sensor, e.g., an inbuilt optical sensor or otherwise a camera. The AutoEdger device comprises a sense-and-respond type of device for seamlessly and quickly maintaining precise hairstyles. Users with a hairstyle (e.g., a facial hairstyle) typically visit barbers for their styling. Their hair starts to regrow after the styling, and the crisp edges between the skin and the hair start to disappear after two or three days from the styling. Assuming that the average hair growth rate is approximately 0.3 mm per day, the AutoEdger device allows a user, himself or herself, to maintain precise or crisp edges between the skin and hair for an extended amount of time. The AutoEdger can detect and cut hair stubble, and can be configured to cut at a certain threshold height, such that the AutoEdger device may cut only the regrown hair (stubble). Therefore, users with a certain hairstyle (e.g., a certain beard style) can use the AutoEdger device to maintain their styles for an extended amount of time.

In some aspects, the techniques described herein relate to a smart personal grooming device including: a body including a handle; a head portion connected to the body and a hair cutting implement; a camera oriented toward the hair cutting implement and configured to capture images of a skin area and a hair area of a user when operating the smart personal grooming device; a sensor configured to measure sensor data based on movement of the smart personal grooming device; a processor communicatively coupled to the camera and the sensor; a memory communicatively coupled to the processor and storing computing instructions that, when executed by the processor, causes the processor to: capture, by the camera, one or more images depicting the skin area of the user and the hair area of the user, detect, based on one or more images, each of the skin area and the hair area, wherein a boundary is defined between the skin area and the hair area; and determine a control state based on the boundary as detected in the one or more images, wherein the control state causes the computing instructions to execute the processor to implement at least one of: (a) activate the hair cutting implement to cause the hair cutting implement to remove hair in the hair area of the user; (b) deactivate the hair cutting implement; (c) activate of a haptic vibrator of the smart personal grooming device; (d) activate an audio device of the smart personal grooming device; (e) initiate a visual indicator of the smart personal grooming device; or (f) changing a cutting speed of the hair cutting implement.

In additional aspects, the techniques described herein relate to a smart personal grooming device, where the sensor is a motion sensor that is configured to measure the sensor data based on movement of the smart personal grooming device.

In additional aspects, the techniques described herein relate to a smart personal grooming device, where the motion sensor is a speed sensor that is configured to measure the sensor data and wherein the processor is configured to determine a speed and a direction of the smart personal grooming device based on the sensor data received from the speed sensor.

In additional aspects, the techniques described herein relate to a smart personal grooming device further including: a learning model stored in the memory and trained with a plurality of images of users when operating the smart personal grooming device, wherein the learning model is configured to output at least one classification based on whether a probability of an image of the plurality of images having an image characteristic is above or below a probability threshold, and wherein the control state is based on the at least one classification.

In further aspects, the techniques described herein relate to a smart personal grooming device, wherein the probability threshold indicates a hair length threshold that includes: (a) a value of approximately 3.5 millimeters (mm); (b) a value selected between 0.3 mm and 3.5 mm; (c) a value selected between 0.3 millimeters (mm) and 1.5 mm; or (d) a value selected between 0.9 millimeters (mm) and 2.5 mm.

In some aspects, the techniques described herein relate to a smart personal grooming device, wherein the at least one classification includes one or more of: (a) a region to cut classification; (b) a region to stop classification; or (c) an edge region classification.

In some aspects, the techniques described herein relate to a smart personal grooming device, wherein the learning model is a neural network-based model.

In some aspects, the techniques described herein relate to a smart personal grooming device, wherein the at least one classification is based on one or more features identifiable with the one or more images, the one or more features including: hair color, hair length, hair pixel intensity, skin color, skin tone, or skin texture.

In some aspects, the techniques described herein relate to a smart personal grooming device, wherein the plurality of images for training the learning model include images having height of 10 to 1944 pixels and width of 10 to 2592 pixels.

In some aspects, the techniques described herein relate to a smart personal grooming device, wherein the plurality of images for training the learning model include images having height of 32 pixels, preferably 48 pixels and a width of 32 pixels, preferably 48 pixels.

In some aspects, the techniques described herein relate to a smart personal grooming device, wherein the plurality of images for training the learning model include images having at least a width within 10 percent of a width of the hair cutting implement.

In some aspects, the techniques described herein relate to the processor analyzing a patch in the one or more images.

In some aspects, the techniques described herein relate to the processor moving the patch in the one or more images either toward the cutter or away from the cutter depending on the determined speed.

In some aspects, the techniques described herein relate to the patch being moved toward the second portion of the one or more images if the determined speed is above a threshold value.

In some aspects, the techniques described herein relate to the patch moving toward the first portion of the one or more images if the determined speed is below a threshold value.

In some aspects, the techniques described herein relate to the boundary is detected in the patch.

In some aspects, the techniques described herein relate to a contact sensor associated with the cutting implement such that the contact sensor is in contact with a skin area of a user, when operating the smart personal grooming device, and wherein the contact sensor is communicatively coupled with the processor.

In some aspects, the techniques described herein relate to a smart personal grooming device further including: subdividing into one or more patches each of the one or more images depicting the skin area of the user and the hair area of the user as captured by the camera, and assigning a patch-based classification to each patch of the one or more patches based on whether hair identified within a respective patch is depicted as above the hair length threshold or below the hair length threshold, wherein the control state is based on each patch-based classification.

In some aspects, the techniques described herein relate to a smart personal grooming device, wherein the computing instructions are further configured, when executed, to cause the processor to: subdivide into one or more patches each of the one or more images depicting the skin area of the user and the hair area of the user as captured by the camera, and assign a patch-based classification to each patch of the one or more patches based on pixel analysis of each of the one or more, wherein the control state is based on each patch-based classification.

In some aspects, the techniques described herein relate to a smart personal grooming device, wherein each patch includes an image region having a width of 160 pixels and a height of 32 pixels.

In some aspects, the techniques described herein relate to a smart personal grooming device including an infrared light source oriented toward the hair cutting implement and configured to illuminate the skin area and hair area of a user when operating the smart personal grooming device.

In some aspects, the techniques described herein relate to a smart personal grooming device further including a second infrared light source oriented toward the hair cutting implement and configured to illuminate the skin area and hair area of a user when operating the smart personal grooming device.

In some aspects, the techniques described herein relate to a smart personal grooming device, wherein the hair cutting implement includes a rotary shaver.

In some aspects, the techniques described herein relate to a smart personal grooming device, wherein the hair cutting implement includes a foil and an undercutter.

In some aspects, the techniques described herein relate to a smart personal grooming device, wherein the hair cutting implement includes a reciprocating blade.

In some aspects, the techniques described herein relate to a smart personal grooming method including: capturing, by a camera, one or more images depicting a skin area of a user and a hair area of the user, wherein the camera is positioned relative to a body including a handle, wherein a head portion is connected to the body and a hair cutting implement, and wherein the camera is oriented toward the hair cutting implement and configured to capture images of the skin area and the hair area of the user when the user uses the hair cutting implement to cut or trim hair, measuring, with a sensor, sensor data based on movement of the smart personal grooming device;

detecting by a processor communicatively coupled to the camera and the sensor, and based on the sensor data and the one or more images, each of the skin area and the hair area, wherein a boundary is defined between the skin area and the hair area; determining, by the processor, a control state based on the boundary as detected in the one or more images; and implementing, by the processor based on the control state, at least one of: (a) activating the hair cutting implement to cause the hair cutting implement to remove hair in the hair area of the user; (b) deactivating the hair cutting implement; (c) activating of a haptic vibrator; (d) activating an audio device; (e) initiating a visual indicator; or (f) changing a cutting speed of the hair cutting implement.

In some aspects, the techniques described herein relate to a tangible, non-transitory computer-readable medium storing instructions for a smart personal grooming device, that when executed by a processor the smart personal grooming device, causes the processor to: capture, by a camera, one or more images depicting a skin area of a user and a hair area of the user, wherein the camera is positioned relative to a body including a handle, wherein a head portion is connected to the body and a hair cutting implement, and wherein the camera is oriented toward the hair cutting implement and configured to capture images of the skin area and the hair area of the user when the user uses the hair cutting implement to cut or trim hair, measuring, with a sensor, sensor data based on movement of the smart personal grooming device, detect by the processor communicatively coupled to the camera and the sensor, and based on the sensor data and the one or more images, each of the skin area and the hair area, wherein a boundary is defined between the skin area and the hair area; determine, by the processor, a control state based on the boundary as detected in the one or more images; and implement, by the processor based on the control state, at least one of: (a) activate the hair cutting implement to cause the hair cutting implement to remove hair in the hair area of the user; (b) deactivate the hair cutting implement; (c) activate a haptic vibrator of the smart personal grooming device; (d) activate an audio device of the smart personal grooming device; (e) initiating a visual indicator of the smart personal grooming device; or (f) changing a cutting speed of the hair cutting implement.

In some aspects, the techniques described herein relate to a cutting method including: capturing, by a camera, one or more images depicting a first body area of a user and a second body area of the user, wherein the camera is positioned relative to a cutting device including a handle and a cutting implement, and wherein the camera is oriented toward the cutting implement and configured to capture images of the first body area and the second body area of the user, detecting by a processor communicatively coupled to the camera, and based on one or more images, each of the first body area and the second body area, wherein a boundary is defined between the first body area and the second body area; subdividing into a plurality of patches each of the one or more images depicting the first body area of the user and the second body area of the user as captured by the camera; assigning a patch-based classification to each patch of the plurality of patches based on pixel analysis of each of the plurality of patches; determining, by the processor, a control state based on the boundary as detected in the one or more images, wherein the control state is based on each patch-based classification; and implementing, by the processor based on the control state, at least one of: (a) activating the cutting implement to cause the cutting implement to remove hair in a hair area of the user; (b) deactivating the cutting implement; (c) activating of a haptic vibrator device; (d) activating an audio device; (e) initiating a visual indicator; or (f) changing a cutting speed of the cutting implement.

In some aspects, the techniques described herein relate to a cutting method, wherein a learning model stored in a memory communicatively coupled to the processor and trained with a plurality of images of user skin areas implements the detecting the first body area and the second body area defining the boundary, wherein the learning model is configured to output at least one classification based on whether a probability of an image of the plurality of images having an image characteristic is above or below a probability threshold, and, wherein the control state is based on the at least one classification.

In some aspects, the techniques described herein relate to a smart personal grooming device including: a body including a handle; a head portion connected to the body and a hair cutting implement; a contact sensor associated with the cutting implement such that the contact sensor is in contact with a skin area of a user, when operating the smart personal grooming device; a processor communicatively coupled to the contact sensor; a memory communicatively coupled to the processor and storing computing instructions that, when executed by the processor, causes the processor to: determine, by the contact sensor a presence of the skin area of the user and subsequently determine by the contact sensor, a presence of a hair area of the user, detect, based on data from the contact sensor, a boundary between the skin area and the hair area; and determine a control state based on the boundary as detected by the contact sensor, wherein the control state causes the computing instructions to execute the processor to implement at least one of: (a) activate the hair cutting implement to cause the hair cutting implement to remove hair in the hair area of the user; (b) deactivate the hair cutting implement; (c) activate of a haptic vibrator of the smart personal grooming device; (d) activate an audio device of the smart personal grooming device; (e) initiate a visual indicator of the smart personal grooming device; or (f) changing a cutting speed of the hair cutting implement.

In addition, the present disclosure includes applying certain of the claim elements with, or by use of, a particular machine, e.g., a smart personal grooming device having a blade. The smart personal grooming device comprises a camera coupled to the shaving device configured to capture images of a skin area and a hair area of a user when operating the smart personal grooming device.

In addition, present disclosure includes improvements in computer functionality or in improvements to other technologies at least because the claims recite that, e.g., use of a camera as attached a smart personal grooming device configured to improve and enhance control or operation of the smart personal grooming device based on image input and analysis. That is, the present disclosure describes improvements in the functioning of the computer itself or “any other technology or technical field” because the control of the smart personal grooming device becomes more precise in its operation, e.g., to activate a hair cutting implement (e.g., a blade) to cause the hair cutting implement to remove hair in a hair area of the user. This improves over the prior art at least because conventional razors or otherwise cutting instruments lack such cutting precision or otherwise control.

In addition, the present disclosure includes specific features other than what is well-understood, routine, conventional activity in the field, or adds unconventional steps that confine the claim to a particular useful application, e.g., devices and methods for smart personal grooming as described herein.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example of a smart personal grooming device in accordance with various embodiments disclosed herein.

FIG. 2A illustrates an example front view of the smart personal grooming device of FIG. 1 as positioned with respect to a skin area and a hair area of a user in accordance with various embodiments disclosed herein.

FIG. 2B illustrates an example side view of the smart personal grooming device of FIG. 1 as positioned with respect to a skin area and a hair area of a user in accordance with various embodiments disclosed herein.

FIG. 3A illustrates a flowchart or algorithm of an example smart personal grooming method in accordance with various embodiments disclosed herein.

FIG. 3B illustrates a flowchart or algorithm of an example smart personal grooming method in accordance with various embodiments disclosed herein.

FIG. 4A illustrates example images of respective hair areas of a user in accordance with various embodiments disclosed herein.

FIG. 4B illustrates example images of respective skin areas of a user in accordance with various embodiments disclosed herein.

FIG. 5A illustrates an image depicting a boundary defined between a skin area and a hair area of a user, and a plurality of patches and related patch-based classifications of the image in accordance with various embodiments disclosed herein.

FIG. 5B illustrates a sequence of images depicting respective boundaries defined between a skin area and a hair area of a user, wherein each image pertains to a plurality of patches and related patch-based classifications in accordance with various embodiments disclosed herein.

FIGS. 6A through 6C illustrate a sequence of images depicting a blade position moving along a skin surface, wherein each image pertains to a plurality of patches and related patch-based classifications in accordance with various embodiments disclosed herein.

FIG. 6D illustrates an example of a skin-hair edge detected between a skin area and a hair area.

FIG. 7A illustrates an example of an additional sensor used in conjunction with the camera of the smart personal grooming device to detect the boundary between the skin area and hair area in accordance with various embodiments disclosed herein.

FIG. 7B illustrates an example of various parameters measured by a distance sensor in conjunction with detection of the boundary between the skin area and hair area in accordance with various embodiments disclosed herein.

FIG. 8 illustrates a flowchart that depicts one or more steps of a method for operating the smart personal grooming device in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

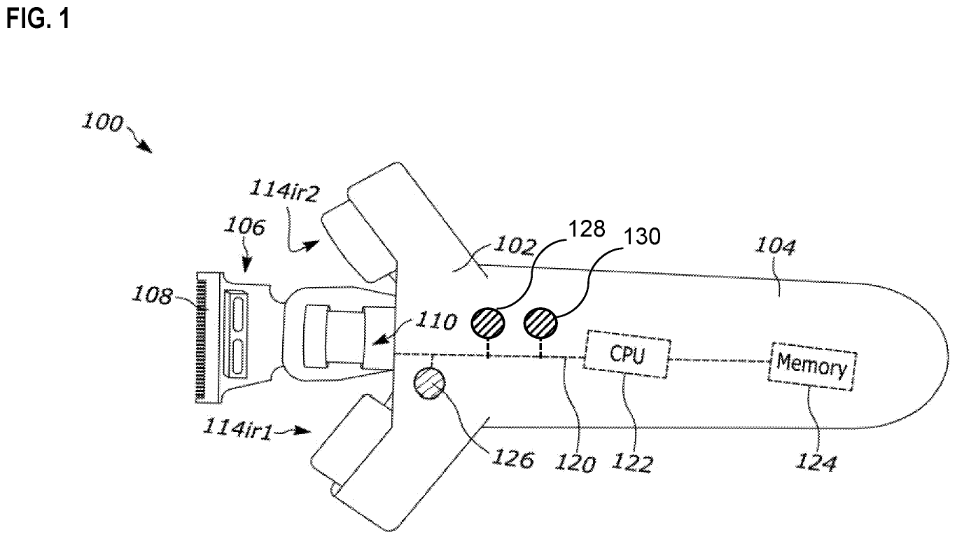

FIG. 1 illustrates an example of a smart personal grooming device 100 (e.g., an example AutoEdger device) in accordance with various embodiments disclosed herein. In the example of FIG. 1, smart personal grooming device 100 comprises a body 102 that includes a handle 104. The smart personal grooming device 100 further comprises a head portion 106 connected to body 102 and a hair cutting implement 108. In various implementations, the hair cutting implement may comprise a rotary shaver, a foil with an undercutter and/or a reciprocating blade. More generally, hair cutting implement 108 may comprise a trimmer, a cutter, or otherwise a blade-based device for cutting hair. In some implementations, haircutting implement 108 may be coupled to a motor (e.g., electric motor) for driving or otherwise actuating the haircutting implement 108, e.g., actuating a trimmer. In some implementations, the hair cutting implement can be removably connected. In various aspects, the hair cutting implement 108 may be detachable, and may comprise a cartridge or other detachable component, for coupling, decoupling, and/or otherwise attaching to head portion 106.

With further reference to FIG. 1, smart personal grooming device 100 further comprise a camera 110 oriented toward the hair cutting implement 108. In some implementations, smart personal grooming device 100 may optionally include one or more infrared light source(s). In the example implementation of FIG. 1, smart personal grooming device 100 includes an infrared light source 114ir1 and a second infrared light source 114ir2, each oriented toward the hair cutting implement 108.

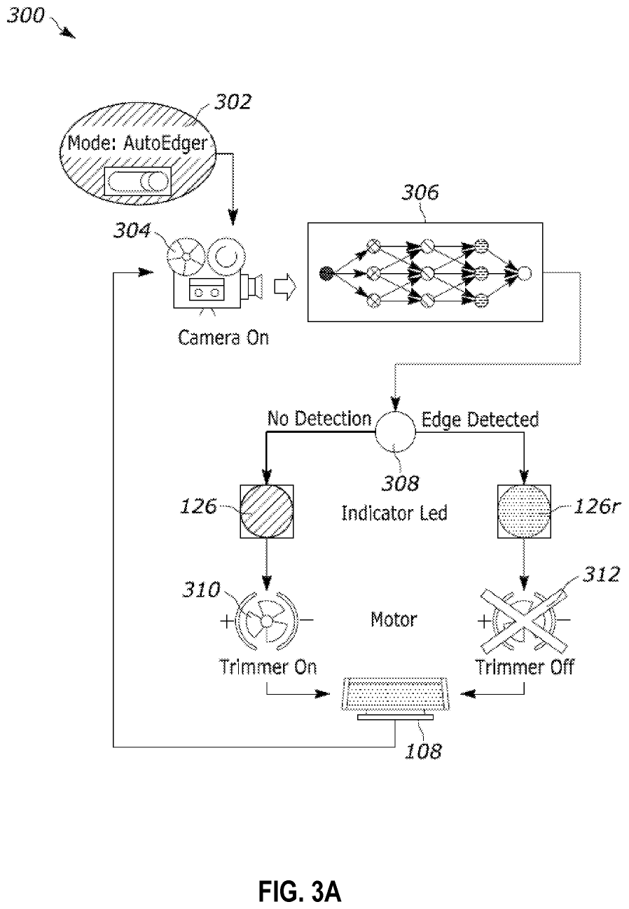

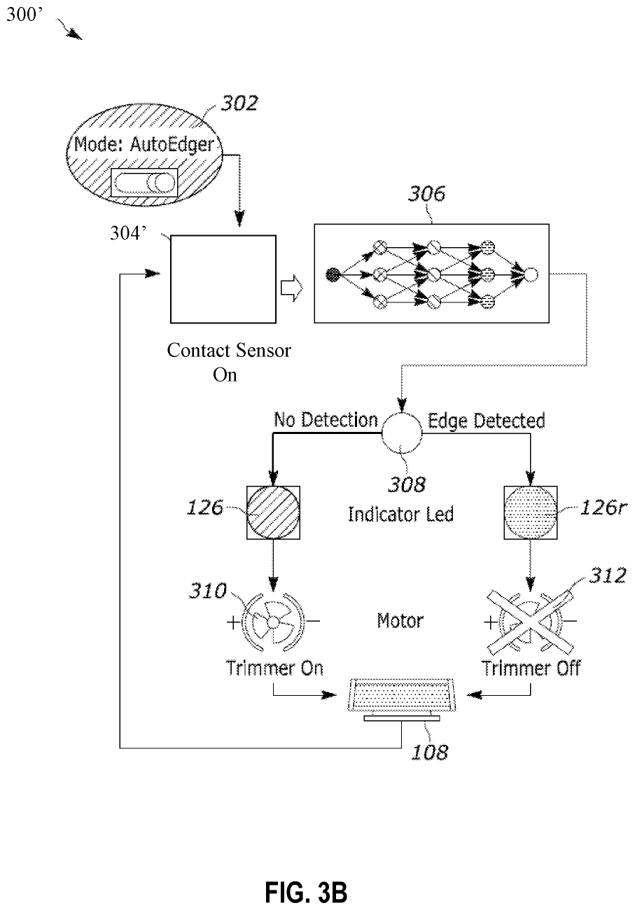

Smart personal grooming device 100 further comprises a processor 122 (e.g., a central processing unit (CPU)) communicatively coupled to the camera 110, through a computing bus 120, which may comprise an electrical or electronic circuit or connection. In some implementations, images or otherwise data, as captured by camera 110, may be provided to a separate or otherwise remote computing device, such as a mobile device or a remote server. Such images or data may be transmitted, for example, by a wireless or wired connection from a transceiver of the smart personal grooming device 100 to a wireless (e.g., WIFI or BLUETOOTH) access point, which may be a receiver of a mobile device (e.g., a mobile device implementing a mobile operating system, such as iOS or ANDROID) and/or a WIFI router connected to a computer network (e.g., the Internet). Where the images or data are received by a mobile device, a processor of the mobile device, may implement instruction stored thereon to analyze the images or data as described herein for processor 122 in view of the algorithm or method implemented by processor 122 (e.g., as described for FIG. 3). For example, a memory of the mobile device could store a learning model for analyzing and the images and data. Once analyzed, the output (e.g., output of the learning model) could be transmitted to the smart personal grooming device 100, via smart personal grooming device 100's transceiver, in order for operation of smart personal grooming device 100 according to the algorithms or methods as described herein, for example, as described herein for FIG. 3A. Where the images or data are received by a server (e.g., via a WIFI router to a computer network, such as the Internet), a processor of the server may analyze the images or data as described herein for processor 122 in view of the algorithm or method implemented by processor 122 (e.g., as described for FIG. 3A). For example, a memory of the server could store a learning model for analyzing and the images and data. Once analyzed, the output (e.g., output of the learning model) could be transmitted to the smart personal grooming device 100, via a computer network (e.g., the Internet) to the WIFI router and to the smart personal grooming device 100's transceiver, in order for operation of smart personal grooming device 100 according to the algorithms or methods as described herein, for example, as described herein for FIG. 3A.

In some implementations, first infrared light source 114ir1 and/or second infrared light source 114ir2 may be communicatively coupled to processor 122 via computing bus 120. The infrared light source(s) (e.g., infrared light source 114ir1 and/or second infrared light source 114ir2) may be mounted next to, around, or in a proximity to camera 110 for uniform illumination in the region of interest on the surface observed (e.g., skin area 132 and/or hair area 134) by camera 110. In various aspects, a given light source may be switched on when the smart personal grooming device 100 is switched on or otherwise provided power. By utilizing camera 110 with the infrared light source(s) (e.g., infrared light source 114ir1 and/or second infrared light source 114ir2), camera 110 can capture image(s) in ambient lighting conditions with wavelengths sufficient for detecting regions of interest (e.g., skin area 132 and/or hair area 134). In some aspects, such wavelengths may correspond to visible spectrum between 400 nm and 700 nm. In some aspects, camera 110 may be configured to have no infrared filter, and thus may have an increased sensitivity to infrared spectrum, being able to detect wavelengths of light of less 800 nm. Still further, in some aspects, to enable the capture of clear images in low lighting conditions (e.g., a dark environment), infrared light source(s) (e.g., infrared light source 114ir1 and/or second infrared light source 114ir2) may be configured to output a wavelength ranging between 800 nm and 980 nm, so that camera 110 can capture image(s) for the detection of regions of interest (e.g., skin area 132 and/or hair area 134) in low lighting conditions.

In some aspects, smart personal grooming device 100 further comprises a light emitting diode (LED) 126 for indicating detection of an edge or boundary for purposes of determining a control state, for example, as described herein. Smart personal grooming device 100 further comprises a memory 124 communicatively via the computing bus 120 coupled to the processor and storing computing instructions that, when executed by the processor 122, causes the processor 122 to implement one or more algorithms or methods, e.g., for example including those as described herein. The computing instructions may comprise instructions compiled from or otherwise interpreted from one or more programming languages including, by way of non-limiting example, Java, C, C++, C#, Python, or the like. The computing instructions, when executed by processor 122, implement algorithms or otherwise methods, which may include, for example, capturing images with camera 110 and/or controlling the cutting implement of the smart personal grooming device 100 or otherwise modifying, updating, or changing a control state or other feature (e.g., vibration) of the smart personal grooming device 100, for example, as described herein with respect to FIG. 3A or otherwise herein.

As depicted in FIG. 1, in some aspects the smart personal grooming device 100 may include a contact sensor 128. In one example, the contact sensor 128 may be a capacitive touch sensor that provides one or more capacitance values. In another example, the contact sensor 128 may be a resistance sensor that provides one or more resistance values. The contact sensor 128 may be communicatively coupled via, the computing bus 120 with the processor 122 and may be configured to transmit contact sensor data to the processor 122. Although FIG. 1 depicts that the contact sensor 128 may be positioned within the handle 104, this is merely for ease of illustration and the contact sensor 128 may be positioned so to contact a surface over which the smart personal grooming device 100 contacts and moves across. In one example, the contact sensor 128 is positioned proximate to the hair cutting implement 108 such that the contact sensor 128 contacts a same surface that is in contact with the hair cutting implement 108. Thus, in one example, the contact sensor 128 may contact the skin area 132 when the hair cutting implement 108 contacts the skin area 132 and the contact sensor 128 may contact the hair area 134 when the hair cutting implement contacts the hair area 134. In this example embodiment, the contact sensor 128 may be advantageously utilized to activate the smart personal grooming device 100 and the hair cutting implement 108 upon the contact sensor 128 making contact the skin area 132. This may advantageously save energy by only activating the hair cutting implement 108 when the contact sensor 128 is in contact with the skin area 132. This contact sensor 128 may also advantageously ensure that the camera 110 is spaced apart from the skin area 132 by a distance that is approximately the focal length of the camera 110, since the contact sensor 128 may be calibrated so to be positioned on the device 100 so that upon contacting a surface (e.g., skin area 132), the surface is at the focal length of the camera 110. In one example the contact sensor 128 has one or more dimensions, such as a length that is less than about 4 cm and a width that is less than about 4 cm.

However, in other embodiments, the contact sensor 128 is positioned in front of the hair cutting implement 108 such that the contact sensor 128 contacts a skin area 132 or hair area 134 prior to the hair cutting implement 108 contacting the respective skin area 132 or hair area 134. In this example embodiment, the contact sensor 128 may be utilized to detect an edge or boundary between the skin area 132 and the hair area 134. In this example, the processor 122 may process the contact sensor data and determine an edge or boundary between the skin area 132 and hair area 134 and deactivate the hair cutting implement 108 upon or just prior to the hair cutting implement 108 reaching said transition. This example embodiment may be practiced without the camera 110 and thus in this example, the smart personal grooming device 100 need not feature the camera 110 in order to detect the edge or transition between the skin area 132 and the hair area 134.

As further shown in FIG. 1, in some embodiments the smart personal grooming device 100 may include a sensor 130. In one embodiment, the sensor 130 is a motion sensor that is configured to measure sensor data related to motion of the smart personal grooming device 100. In one example embodiment, the sensor 130 is a speed sensor that is configured to measure sensor data related to a speed and a direction of the movement of the smart personal grooming device 100. In other embodiments, the sensor 130 is one an optical speed sensor, an IMU sensor, a roller, or any sensor configured to measure sensor data which can be utilized to determine one or more parameters related to motion of the smart personal grooming device 100.

The sensor 130 may be communicatively coupled to the processor 122 via, the computing bus 120. In one example, the speed sensor 130 may be positioned to measure sensor data. This sensor data may be transmitted to the processor 122 which may then use the sensor data to determine a value of a speed and a direction of speed of the smart personal grooming device 100 relative to a surface, such as the skin area 132 and/or the hair area 134 of the user. In some embodiments, the speed sensor may feature an internal processor which is configured to process the measured sensor data to determine the value of the speed and the direction of speed, which is then transmitted from the speed sensor to the processor 122. In one example embodiment, the speed sensor 130 is an optical speed sensor that transmits an optical signal and detects a reflected signal from the surface. A processor, such as the processor 122 may process the reflected signal to determine a value of the speed and the direction of the speed of the smart personal grooming device 100 relative to the surface (e.g. skin area 132 or hair area 134) of the user. In some examples, the camera 110 may be used as the speed sensor 128, in which the processor 122 may compare two captured images from the camera 110 at two different time periods. In this example, the processor 122 may determine the magnitude and direction of speed of the smart personal grooming device 100 along the surface based on comparing the two captured images and based on the time difference between the captured two images. For example, the processor 122 may determine a spatial shift of a fixed object between the two captured images and along with the known time difference between the two captured images determine a magnitude and direction of the speed of the smart personal grooming device 100 along the surface of the user. In one example, the speed sensor 130 may measure a stroke speed of the user. In still another example, the speed sensor 130 may be an optical speed sensor that may measure a magnitude of the stroke speed between about 1 mm/see to about 50 mm/sec.

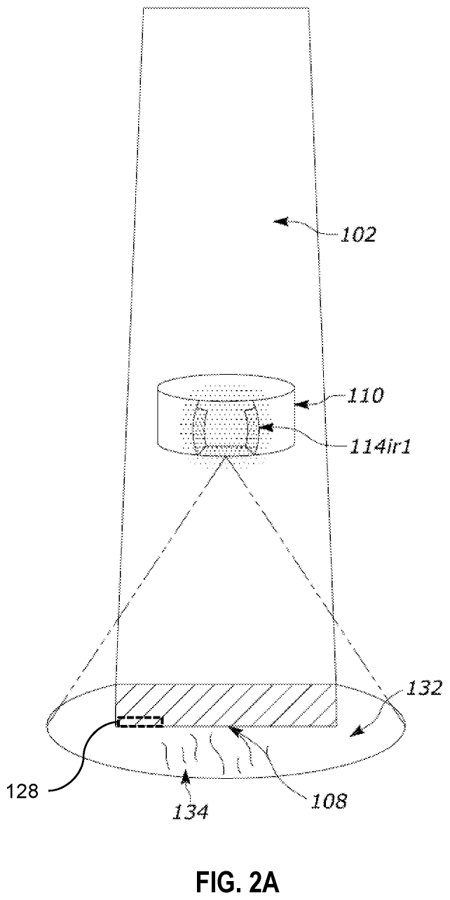

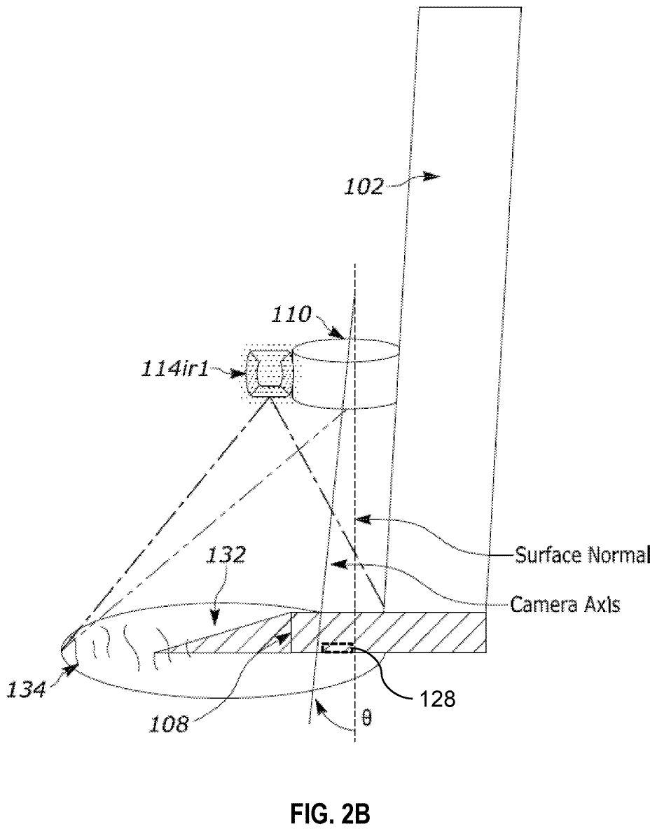

FIG. 2A illustrates an example front view of the smart personal grooming device 100 of FIG. 1 as positioned with respect to a skin area 132 and a hair area 134 of a user in accordance with various embodiments disclosed herein. In particular, as shown for FIG. 2A, camera 110 is attached to body 102 of smart personal grooming device 100. In various implementation, camera 110 may be switched on, or otherwise powered by a power source (e.g., battery, wired power source, or otherwise electrical connection) when the device is switched on or activated.

In various implementations, camera 110 may comprise an optical sensor capable of imaging a given area (e.g., a skin or hair area) of a user. Camera 110 may have an image resolution to capture images of a certain pixel density of the skin area 132 and a hair area 134 of the user near, at, or otherwise proximal to the location of the hair cutting implement 108. In one non-limiting example, camera 110 may comprise a low-resolution camera for capturing images at least 32 pixels wide by 32 pixels high.

In addition, camera 110 may be positioned in a proximity to an infrared light source, e.g., infrared light source 114ir1. For example, camera 110 may be mounted in a position to capture images illuminated by an infrared light source, e.g., infrared light source 114ir1. The camera 110 may be mounted without any infrared filter. As a result, it can capture images in the near-infrared (IR) spectrum. As shown for FIG. 2A, infrared light source 114ir1 is oriented toward hair cutting implement 108 and is configured to illuminate skin area 132 and hair area 134 of a user when operating the smart personal grooming device 100. While not shown in FIG. 2A, a second infrared light source (e.g., infrared light source 114ir2) can also be oriented toward the hair cutting implement 108 and may also be configured to illuminate skin area 132 and hair area 134 of the user when operating the smart personal grooming device. Use of infrared light source(s) is one way to determine whether the device is touching the user's skin surface, skin area, or hair area. It should be understood, however, that additional or different configurations or components could be used to determine if the device is touching the skin surface, skin area, or hair area to be treated. By way of non-limiting example, this can include time-of-flight (ToF) sensor(s) to determine skin surface, skin area, or hair area by detecting ToF data as transmitted and received by camera 110. Additionally, or alternatively, this can include a contact sensor 128 as depicted in FIG. 2A that is configured to detect the skin area 132. In one example, the contact sensor 128 may be a capacitive touch sensor positioned on the end of the smart personal grooming device 100 that can detect the skin surface, skin area, or hair area through electrical capacitance. Still further, additionally, or alternatively, this can also include detecting, by processor 122, the movement of a wheel encoder positioned on the end of the smart personal grooming device 100 that can detect the skin surface, skin area, or hair area when actuated (rolled) on the surface. In an example embodiment, the width of the contact sensor 128 (as shown in FIG. 2B) may be at least 10% of the width of the hair cutting implement 108.

In an example embodiment, the camera 110 may be spaced a vertical distance of about 2.5 cm from a bottom surface of the contact sensor 128 when the smart personal grooming device 100 is on a flat horizontal surface (as shown in FIGS. 2A and 2B). In this example embodiment, the camera 110 field-of-view may envelope the hair cutting implement 108 (e.g. the hair cutting implement 108 should fit within the width of the captured image). In this example, a focal length of the camera 110 may be adjusted to enable this feature.

In still another example embodiment, the contact sensor has a minimum height of about 1 mm and a minimum width of about 1 mm.

More generally, camera 110 is configured to capture image(s) depicting the skin area 132 of the user and the hair area 134 of the user. Processor 122 may then detect, based on pixel data within the images, each of the skin area 132 and/or the hair area 134. A boundary may be defined between the skin area 132 and the hair area 134, where the boundary may comprise an edge between the skin and hair, e.g., a linear area with skin having stubble and an area with a higher hair forming a beard of the user. The boundary or otherwise edge can be, at least initially, created, for example, by a barber or user using a razor, trimmer, or other device with a cutting implement.

Each of the skin area 132 and the hair area 134 defining the boundary may be detected based on pixel data within the images captured by camera 110. Each of these images may comprise pixel data (e.g., RGB data) representing feature data corresponding to skin and/or hair, within the respective image. Generally, as described herein, pixel data comprises individual points or squares of data within an image, where each point or square represents a single pixel within an image. Each pixel may be a specific location within an image. In addition, each pixel may have a specific color (or lack thereof). Pixel color may be determined by a color format and related channel data associated with a given pixel. For example, a popular color format includes the red-green-blue (RGB) format having red, green, and blue channels. That is, in the RGB format, data of a pixel is represented by three numerical RGB components (Red, Green, Blue), that may be referred to as a channel data, to manipulate the color of pixel's area within the image. In some implementations, the three RGB components may be represented as three 8-bit numbers for each pixel. Three 8-bit bytes (one byte for each of RGB) is used to generate 24-bit color. Each 8-bit RGB component can have 256 possible values, ranging from 0 to 255 (i.e., in the base 2 binary system, an 8-bit byte can contain one of 256 numeric values ranging from 0 to 255). This channel data (R, G, and B) can be assigned a value from 0 255 and be used to set the pixel's color. For example, three values like (250, 165, 0), meaning (Red=250, Green=165, Blue=0), can denote one Orange pixel. As a further example, (Red=255, Green=255, Blue=0) means Red and Green, each fully saturated (255 is as bright as 8 bits can be), with no Blue (zero), with the resulting color being Yellow. As a still further example, the color black has an RGB value of (Red=0, Green=0, Blue=0) and white has an RGB value of (Red=255, Green=255, Blue=255). Gray has the property of having equal or similar RGB values. So (Red=220, Green=220, Blue=220) is a light gray (near white), and (Red-40, Green=40, Blue=40) is a dark gray (near black).

In this way, the composite of three RGB values creates the final color for a given pixel. With a 24-bit RGB color image using 3 bytes there can be 256 shades of red, and 256 shades of green, and 256 shades of blue. This provides 256×256×256, i.e., 16.7 million possible combinations or colors for 24-bit RGB color images. In this way, the pixel's RGB data value shows how much of each of Red, and Green, and Blue pixel is comprised of. The three colors and intensity levels are combined at that image pixel, i.e., at that pixel location on a display screen, to illuminate a display screen at that location with that color. In is to be understood, however, that other bit sizes, having fewer or more bits, e.g., 10-bits, may be used to result in fewer or more overall colors and ranges.

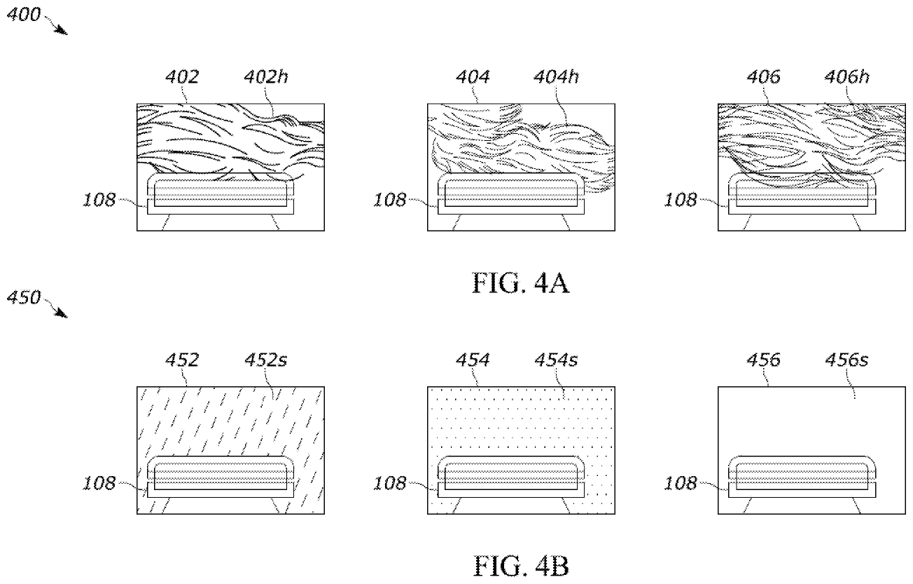

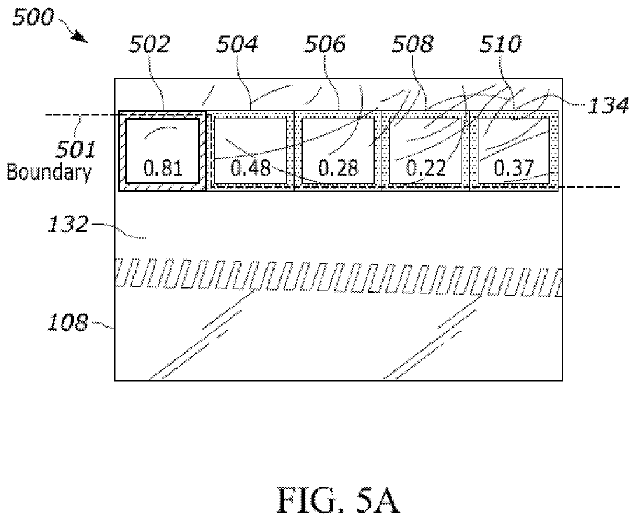

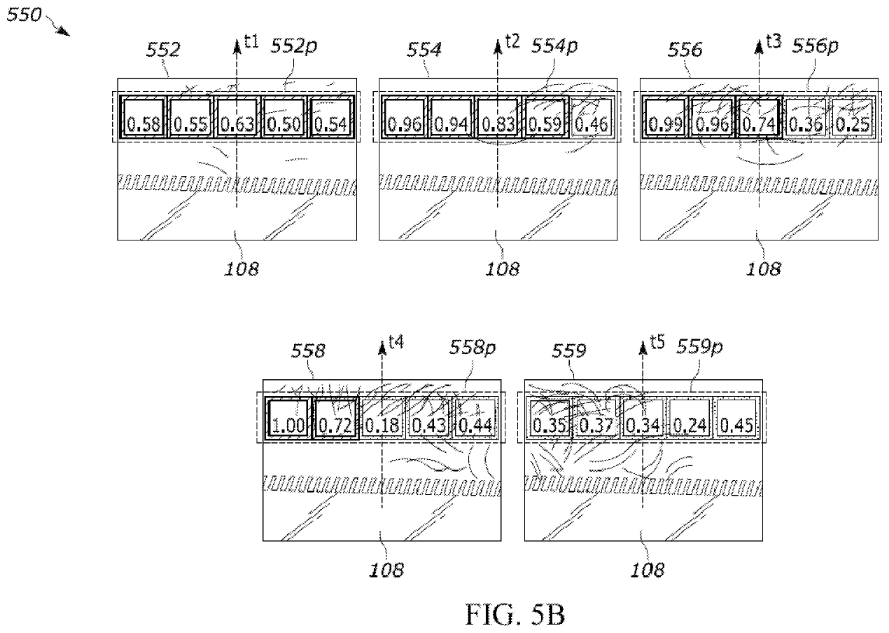

As a whole, the various pixels, positioned together in a grid pattern, form a digital image (e.g., any of the images as described herein, e.g., for FIGS. 4A, 4B, 5A, and/or 5B). A single digital image can comprise thousands or millions of pixels. Images can be captured, generated, stored, and/or transmitted in a number of formats, such as JPEG, TIFF, PNG and GIF. These formats use pixels to store represent the image.

However, in some embodiments, the camera 110 may not be used to capture image(s) which depict the skin area 132 and the hair area 134 and are processed by the processor 122 to detect the boundary between the skin area 132 and the hair area 134. In these embodiments, the contact sensor 128 may be used to measure contact sensor data of the surface over which the device 100 is moved. Such contact sensor data may include contact sensor data indicating when the contact sensor 128 is in contact with the skin area 132 and contact sensor data indicating when the contact sensor 128 is in contact with the hair area 134. The contact sensor 128 may transmit this contact sensor data to the processor 122 which may process the contact sensor data in order to detect, based on contact sensor data, each of the skin area 132 and/or the hair area 134. In one example, the processor 122 may process the contact sensor data and determine a boundary (or hair-skin edge) based on a change in the contact sensor being greater than a threshold as indicative of a transition from the contact sensor 128 contacting the skin area 132 to the contact sensor contacting the hair area 134. A boundary may be defined between the skin area 132 and the hair area 134, where the boundary may comprise an edge between the skin and hair, e.g., a linear area with skin having stubble and an area with a higher hair forming a beard of the user. The boundary or otherwise edge can be, at least initially, created, for example, by a barber or user using a razor, trimmer, or other device with a cutting implement. In these embodiments, the device 100 may be provided without the camera 110.

In various aspects, processor 122 is configured to determine control state of the smart personal grooming device 100 based on the boundary as detected in the one or more images and/or as detected based on the contact sensor data. For example, the control state may cause processor 122, when executing the computing instructions, to implement algorithms or otherwise methods, for example, as described herein with respect to FIG. 3A (processing image data from the camera 110) or FIG. 3B (processing contact sensor data from the contact sensor 128) or otherwise herein. For example, in one aspect, such algorithm may comprise actuating a hair cutting implement 108 to cut the user's hair stubble.

FIG. 2B illustrates an example side view of the smart personal grooming device 100 of FIG. 1 as positioned with respect to skin area 132 and hair area 134 of a user in accordance with various embodiments disclosed herein. FIG. 2B shows the orientation of camera 110 and infrared light source 114ir1 with respect to body 102 and hair cutting implement 108. Generally, camera 110 is oriented toward hair cutting implement 108 and configured to capture images of skin area 132 and hair area 134 of the user when the user operates the smart personal grooming device 100. The camera 110 is configured to capture one or more images, e.g., a video or a series of frames or images, while the user operates the smart personal grooming device 100. Analysis of the images enables processor 122 to control or otherwise change operation or features of the smart personal grooming device 100 based on interpretation of the optical sensor feedback signal (e.g., analysis of the pixel data).

As further shown in FIG. 2B, the device 100 may include the contact sensor 128 that may be positioned adjacent to the hair cutting implement 108 such that contact between the contact sensor 128 and the skin area 132 corresponds with contact between the hair cutting implement 108 and the skin area 132. In some examples, the contact sensor 128 may be positioned in front of the hair cutting implement 108 such that the contact sensor 128 detects a skin area 132 or a hair area 134 prior to the hair cutting implement 108 contacting said skin area 132 or hair area 134. In this example embodiment, the contact sensor 128 may be utilized to detect a transition between the skin area 132 and hair area 134 prior to the hair cutting implement 108 reaching said transition.

Thus, in this example, the contact sensor 128 may be used to detect the transition between the skin area 132 and hair area 134 (e.g. without use of the camera 110) and thus transmit a signal to the processor 122 which can deactivate the hair cutting implement 108 prior to or upon the hair cutting implement 108 reaching the transition.

In some implementations, camera 110, or its lens, may be configured to have a constant focal length, or otherwise camera distance, relative to the skin area 132, hair area 134, and/or hair cutting implement 108. In a zoomed-in implementation, such focal length or otherwise camera distance may comprise a 2 millimeters (mm) to 5 mm distance from a lens of camera 110 to the skin area 132, hair area 134, and/or hair cutting implement 108. In another implementation, having a larger field of view for longer distances, such focal length or otherwise camera distance may comprise a 5 mm or greater distance from a lens of camera 110 to the skin area 132, hair area 134, and/or hair cutting implement 108. In some embodiments, the contact sensor 128 may be used to activate the camera 110 to commence capture of images from the skin area 132 and hair area 134. In this example, upon the contact sensor 128 detecting contact with the skin area 132, the contact sensor 128 may transmit contact sensor data to the processor 122 indicating contact with the skin area 132. The processor 122 may then transmit a signal to the camera 110 to commence capture of images of the skin area 132 and hair area 134, upon receiving this contact sensor data. This example embodiment may advantageously ensure that the camera 110 is only activated to capture images when the camera 110 is spaced from the skin area 132 by a distance that is approximately equal to the focal length of the camera 110. In this example embodiment, the contact sensor 128 is calibrated such that upon detecting contact with the skin area 132, the skin area 132 is spaced apart from the camera 110 by a distance that is approximately equal to the focal length of the camera 110. This example embodiment also may advantageously save energy since it may ensure that the camera 110 (or the device 100) is only activated when the hair cutting implement 108 is in contact with the skin area 132 such that the skin area 132 is at the focal length of the camera 110.

Additionally, or alternatively, a camera orientation of camera 110 may be offset. For example, as shown for FIG. 2B, camera 110 may have an offset of +/−30 degrees relative to a surface angel of hair cutting implement 108. More generally, the angle between a camera axis of camera 110 and the surface normal can vary between 0 and 60 degrees. Offsetting, angling, or otherwise positioning the camera relative to skin area 132, hair area 134, and/or hair cutting implement 108 enables capturing of clear images for processing by processor 122. The capture of such clear images reduces noise in such images, which allows for precise and enhanced image analysis and thus control of the smart personal grooming device 100 due to less error prone image analysis.

FIG. 3A illustrates a flowchart or algorithm of an example smart personal grooming method 300 in accordance with various embodiments disclosed herein. In various implementations, smart personal grooming method 300 may comprise an algorithm, implemented by computing instructions, and executed by processor 122 of the smart personal grooming device 100, and stored in memory (e.g., memory 124). In some implementations, smart personal grooming method 300 may be implemented when a user has selected that an AutoEdger mode (block 302) be turned on or otherwise activated. Such selection or activation may be implemented via a switch, button, or display screen of the smart personal grooming device 100. In other implementations, smart personal grooming method 300 may be implemented when the smart personal grooming device 100 itself is powered on, e.g., in an always-on mode.

At block 304, smart personal grooming method 300 comprises capturing, by a camera (e.g. camera 110), one or more images depicting a skin area (e.g., skin area 132) of a user and a hair area (e.g., hair area 134) of the user, for example, as described herein for FIGS. 1, 2A, and 2B. The images may comprise one more frames of a video, e.g., where camera 110 comprises a video camera for capturing image(s) (e.g., frames) during operation of smart personal grooming device 100. The image(s) are captured while the user uses the hair cutting implement (e.g., hair cutting implement 108) to cut or trim hair as described herein.

At block 306, smart personal grooming method 300 comprises detecting by a processor (e.g., processor 122) communicatively coupled to the camera (e.g., camera 110), and based on one or more images, each of the skin area (e.g., skin area 132) and the hair area (e.g., hair area 134). In various aspects, the boundary may be an edge, line, or otherwise region be defined between the skin area and the hair area. More generally, a hairstyle may be defined by a predefined edge or boundary between the skin and hair, e.g., an edge of a beard or otherwise. For example, the boundary may be defined along a region where hair longer is longer than a given length. Smart personal grooming method 300 includes detecting the boundary, or otherwise predefined edge based on image analysis. This can include taking, as input from the camera 110, the one or more images and detecting the presence of hair longer than a threshold length. Such detection provides a region or area of the boundary or edge between the hair and the skin, e.g., an edge of a beard. The output of personal grooming method 300, or otherwise algorithm, is provided to instruct processor 122 to control smart personal grooming device 100, including, for example, to control the hair cutting implement 108. For example, such control may comprise outputting an electronic or digital command or signal to stop the trimmer when the predefined edge or otherwise boundary between the skin and hair (e.g., beard) is detected when the device moves from the skin to the hair and vice versa.

In some implementations, a learning model stored in the memory (e.g., memory 124) of smart personal grooming device 100. The learning model may be accessed by processor 122 implementing computing instructions to provide input and receive output from the learning model. The learning model may be trained with a plurality of images of users when operating the smart personal grooming device 100. For example, in some implementations, the plurality of images for training the learning model comprise images having height of 10 to 1944 pixels and width of 10 to 2592 pixels. In such implementations, a maximum resolution size of the camera (e.g., camera 110) may comprise a 2592 by 1944 resolution size. It should be understood, however, that different cameras having different resolution sizes may also be used, which could cause the image size and/or height, and related pixel density therefore, to be differently captured based on the cameras dimensioning and resolution sizing.

In various implements, the resolution may be changed, adjusted, or otherwise updated to focus on the areas of interest (e.g., skin area 132 and hair area 134) and/or otherwise enhance image quality for the purpose of training and/or using image(s), and therefore related pixel data, which improves the training and/or use of the underlying learning model. For example, in some implementations, a range of pixels (e.g., 25 pixels to 40 pixels) may be used. For example, such range may be based on width of a cutting implement (e.g., hair cutting implement 108). Additionally, or alternatively, the range may be based on distance of the camera to the user's skin. Additionally, or alternatively, the range may be based on camera resolution, where, for example, the camera has a resolution and/or is positioned at a certain distance from the user's skin such that a view or otherwise image of the user's skin where the blade contacts the user's skin comprises an area having a 25 to 40 pixel height and a 25 to 40 pixel width.

In various aspects, the height and width of the images can be fixed, where the image size and height used for training have the same image size and height as the images used for input into the model for detecting the boundary or otherwise edge. In one non-limiting example, the images for training the learning model, as well as for later using the trained model, comprise images having height of 32 pixels and a width of 32 pixels. In other implementations, the images for training the learning model, as well as for later using the trained model, comprise images having at least a width within 10 percent of a width of the hair cutting implement 108. It is to be understood, however, that other pixel heights and widths may be utilized herein. For example, pixel sizing or resolution of images captured by camera 110 may be configured to be larger or smaller depending on the size of an area of hair to be removed or size of the hair removal device itself (e.g., the smart personal grooming device 100).

In various implementations, and as indicated in FIG. 3A, the learning model comprises a neural network-based model. In such implementations, the neural network-based model is trained on images as input, including the pixel data of the images that detail areas of interest (e.g., skin area 132 and hair area 134). In some aspects, the neural network is trained using a back propagation to adjust the weights of each node in the neural network to detect hair and/or skin for the purpose of detecting the boundary or edge as described herein. The neural network is trained to output a classification to determine a boundary or edge between skin and hair (e.g., a beard) and/or state of the trimmer head.

More generally, in various embodiments, the learning model (e.g., as stored in memory 124) is an artificial intelligence (AI) based model, such as a machine learning model, trained with at least one AI algorithm. Training of learning model involves image analysis of the training images to configure weights of learning model, and its underlying algorithm (e.g., machine learning or artificial intelligence algorithm) used to predict and/or classify future images. For example, in various embodiments herein, generation of learning model involves training learning model with the plurality of training images of a plurality of users, where each of the training images comprise pixel data of a skin areas and hair areas of respective users. In some embodiments, one or more processors of a server or a cloud-based computing platform may receive the plurality of training images of the plurality of users via a computer network (e.g., the Internet). In such embodiments, the server and/or the cloud-based computing platform may train the learning model with the pixel data of the plurality of training images. More generally, the images may be trained by a computing device sufficient to access a large number of images for training the learning model as described herein.

In various embodiments, a learning model, as described herein, may be trained using a supervised or unsupervised machine learning program or algorithm. The machine learning program or algorithm may employ a neural network, which may be a convolutional neural network, a deep learning neural network, or a combined learning model or program that learns in two or more features or feature datasets (e.g., pixel data) in a particular areas of interest. The machine learning model may also include support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the artificial intelligence and/or machine learning based algorithms may be included as a library or package executed by a computing device, such as a server, for training the learning model as describe herein. For example, libraries may include the TENSORFLOW based library, the PYTORCH library, and/or the SCIKIT-LEARN Python library.

Machine learning may involve identifying and recognizing patterns in existing data (such as training a model based on pixel data within images having pixel data of a skin area and/or hair area of a respective individuals) in order to facilitate making prediction(s) or classification(s) for subsequent data (such as using the model on new pixel data of a new individual in order to determine one or more classifications, and related classification values, for a skin area or a hair of a user as described herein).

Machine learning model(s), such as the learning model described herein for some embodiments, may be created and trained based upon example data (e.g., “training data” and related pixel data) inputs or data (which may be termed “features” and “labels”) in order to make valid and reliable predictions or classifications for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict or classify, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction or classification accuracy when given test level or production level data or inputs, is generated. The disclosures herein may use one or both of such supervised or unsupervised machine learning techniques. In addition, in various aspects, the learning model may be updated, over time, with new images as new training data in order to improve the accuracy of the predictions and/or classifications as output by the learning model.

At block 308, smart personal grooming method 300 comprises determining, by the processor 122, a control state of the smart personal grooming device 100 based on the boundary as detected in the one or more images. In various aspects, the boundary may be determined by analysis of the pixel data. For example, in various implementations, the learning model (e.g., as stored in memory 124) is configured to output at least one classification based on whether a probability of an image of the plurality of images having an image characteristic is above or below a probability threshold. In one example, the image characteristic may be the pixel data that may indicate a hair length within the image. In this example, the probability threshold may indicate a hair length threshold and the probability may be whether a hair length within the image (as indicated by the pixel data) is above a hair length threshold or below the hair length threshold. In this example, the hair length threshold may comprise a value or setting stored in memory 124 of smart personal grooming device 100. For example, a hair threshold length can be based on measurable values of hair stubbles (i.e., newly growing hair in the skin area 132). More generally, the hair length threshold value may comprise a hair stubble value of less than 3500 (micrometer) μm length. Additionally, or alternatively, a hair length threshold value may comprise a range of values. For example, the hair length threshold may comprise: (a) a value of approximately 3.5 millimeters (mm); (b) a value selected between 0.3 mm and 3.5 mm; (c) a value selected between 0.3 millimeters (mm) and 1.5 mm; and/or (d) a value selected between 0.9 millimeters (mm) and 2.5 mm. Still further, a range may be based on a predetermined time period of growth of hair. For example, in some implementations, a range could be between 0.3 mm and 3.5 mm for 1 to 7 days of growth. Additionally, or alternatively, a range could be between 0.3 mm to 1.5 mm for 1 to 3 days of growth. Additionally, or alternatively, a range could be between 0.9 mm to 2.5 mm for 3 to 5 days of growth, preferably from between about 1 to about 5 days of growth.

With further reference to FIG. 3A, at block 308, the control state of the smart personal grooming device 100 can be based on the at least one classification, e.g., as determined based on the boundary as detected in the one or more images. Example classifications (e.g., as output by the learning model) may comprise any one or more of a region to cut classification, a region to stop classification, and/or an edge region classification. For example, a region to cut classification (which could be identified or labeled as an “Region to Cut”) could be assigned to regions of an image where hair is detected having a value at or below the hair length threshold. Further, a region to stop classification (which could be identified or labeled as an “Region to Stop”) could be assigned to regions of an image where bare skin is detected or otherwise where hair is detected having a value at or above the hair length threshold. Regions identified in an image (e.g., in the pixel data of an image) having hair both above and below the hair length threshold could be identified as an edge region classification (which could be identified or labeled as an “Edge Region”). In this way, the images captured by camera 110 may be captured and input into the learning model to detect the predefined edge, or otherwise boundary, between the skin, stubble, and/or hair.

In various implementations, each of the one or more classifications may be based on one or more features identifiable with the one or more images and/or pixel data thereof. For example, the one or more features identifiable in the images or by the pixel data may comprise hair color, hair pixel intensity, hair length, skin color, skin tone, or skin texture. The image classifications are learned from training a learning-based model (e.g., the learning model) on pixel data of images of one or more individuals comprising pixel data of skin areas and hair areas of a plurality of individuals. For example, the learning model may be trained with pixel data (e.g., including RGB values of pixel data) a plurality of training images of respective skin and hair areas of users. The weights of the model may be trained via analysis of various RGB values of individual pixels of a given image. For example, dark or low RGB values (e.g., a pixel with values R=25, G=28, B-31) may indicate presence of hair or stubble against the user's skin. Still further, pixel values having a pattern of different colored pixels dotted in the given area may indicate presence of hair or stubble against the user's skin. By contrast, pixel values having the same or similar value in a linear or stringed manner may represent longer hair or hair having a certain hair length threshold. Still further, pixel values indicating the absence of skin tones may further indicate a hair area (as opposed to a skin area) within a given image. Still further, a line or edge defined in image(s) by pixel data having different or contrasting colors (e.g., RGB values) may indicate the presentence of an edge or boundary of a given hairline (e.g., a beard). In this way, pixel data (e.g., detailing one or more features of an individual, such as user skin areas hair areas having different specific pixel RGB values(s) as identifiable within 10,000s training images may be used to train or use the learning imaging model to detect, based on one or more images, each of the skin area and the hair area, where, at least in some images, a boundary is defined between the skin area and the hair area. The control state of smart personal grooming device 100 can then be determined therefrom.

In one example, the hair pixel intensity feature identifiable in the image may be assigned a greyscale value, where a 0 value corresponds to black and a 1 value corresponds to white. Thus, in this example, the learning model may be trained with greyscale pixel data for the hair pixel intensity.

With further reference to FIG. 3A, block 308 of smart personal grooming method 300 comprises implementing, by the processor based on the control state, at least one of several algorithms or methods. For example, if no boundary, edge, stubble, is detected (e.g., based on detected hair along a boundary being below a hair length threshold value based on the image or pixel analysis), then at block 310, smart personal grooming method 300 comprises activating the hair cutting implement (e.g., hair cutting implement 108) to cause the hair cutting implement to remove hair in the hair area of the user. This may include, by way of non-limiting example, turning a motor of smart personal grooming device 100 on in order to trim or cut hair. This may further include updating the LED 126 (e.g., chaining it to a green color) to indicate that the motor is on.

By contrast, at block 308, if a boundary, edge, stubble, is detected (e.g., based on detected hair along a boundary being above or at a hair length threshold value based on the image or pixel analysis), then at block 310, smart personal grooming method 300 comprises deactivating the hair cutting implement (e.g., hair cutting implement 108) to cause the hair cutting implement to stop. This may include, by way of non-limiting example, turning a motor of smart personal grooming device 100 off. This may further include updating the LED 126r (e.g., chaining it to a red color) to indicate that the motor is off.

Additionally, or alternatively, smart personal grooming method 300 may comprise implementing, by the processor 122 based on the control state, an algorithm comprising activating of a haptic vibrator of the smart personal grooming device 100, activating an audio device of the smart personal grooming device 100, and/or initiating a visual indicator (e.g., LED 126). of the smart personal grooming device. Any one or more of the haptic vibrator, audio device, visual indicator may indicate, for example, when the boundary is detected and/or when the motor of the smart personal grooming device 100 is turned on or off.

Additionally, or alternatively, smart personal grooming method 300 may comprise implementing, by the processor based on the control state, an algorithm comprising changing a cutting speed of the hair cutting implement. This may include, for example, changing a stroke speed during a shaving session of the user. For example, when the smart personal grooming device 100 is operating, the stroke speed of the motor of the smart personal grooming device 100 can be varied between a range of speeds such as 1 mm/s to 50 mm/s.

FIG. 3B illustrates a flowchart or algorithm of an example smart personal grooming method 300′ in accordance with various embodiments disclosed herein. In various implementations, smart personal grooming method 300′ may comprise an algorithm, implemented by computing instructions, and executed by processor 122 of the smart personal grooming device 100, and stored in memory (e.g., memory 124). Each step of the method 300′ of FIG. 3B may be similar to the method 300 of FIG. 3A with the exception of the features discussed herein. Thus, for purposes of this description, only those steps of the method 300′ of FIG. 3B which may differ from the steps of the method 300 of FIG. 3A are explicitly described herein.

Unlike block 304 of the method 300 of FIG. 3A, where images are captured by the camera 110, in block 304′ of the method 300′ of FIG. 3B a step of capturing, by the contact sensor 128, contact sensor data indicating one of a skin area (e.g., skin area 132) of a user or a hair area (e.g., hair area 134) of the user is performed. The contact sensor data may be captured while the user uses the hair cutting implement (e.g., hair cutting implement 108) to cut or trim hair as described herein.

Block 306 of the method 300′ of FIG. 3B may be performed using similar techniques as block 306 of the method 300 of FIG. 3A, with the exception that contact sensor data from the contact sensor 128 is used (rather than image data from the camera 110) to train the learning model or neural network or generate the machine learning model utilized to detect the edge in block 308 between the skin area 132 and the hair area 134.

In block 306 of the method 300′ of FIG. 3B, the learning model may be stored in the memory and trained with a plurality of values relating to resistance (e.g. from a resistance contact sensor 128) of skin area and resistance of hair area of users when operating the smart personal grooming device. In another example, in block 306 the learning model may be stored in the memory and trained with a plurality of values relating to capacitance (e.g. from a capacitance contact sensor 128) of skin area and resistance of hair area of users when operating the smart personal grooming device.

In block 306 of the method 300′ of FIG. 3B, the learning model may be configured to output at least one classification based on comparison of the one or more resistance values or one or more capacitance values to a threshold value. In one example, the control state is based on the at least one classification.

The contact sensor 128 working with the learning model may include one or more contact sensors. The value that is generated from these contact sensor(s) may go in the learning model. The output of the learning model may be the classification as to whether the device 100 is touching the hair area 134 (e.g. high resistance/high capacitance area) or touching the skin area 132 (e.g. low resistance/low capacitance area).

In one example, the contact sensor 128 may be used just using a threshold and the at least one classification can be achieved if the value generated by the sensor is above or below the threshold. If the device uses this threshold based approach, the learning model may not be necessary.

FIG. 4A illustrates example images 400 (e.g., images 402, 404, and 406) of respective hair areas (e.g., 402 h, 404h, and 406h) of a user in accordance with various embodiments disclosed herein. As shown for FIG. 4A, each of images 402, 404, and 406 depicts hair cutting implement 108 (e.g., a trimmer) engaged in trimming hair, or otherwise positioned next to hair, in respective hair areas 402h, 404h, and 406h. Each of the images 402, 404, and 406 comprise pixel data, which may be analyzed for detecting or otherwise identifying hair areas (e.g., 402h, 404h, and 406h) as described for smart personal grooming method 300, or otherwise the algorithm thereof, for FIG. 3A or elsewhere herein. Further, the pixel data of images 402, 404, and 406 may be used for training the learning model as described herein, including for training the learning model to classify the images 402, 404, and 406 as a region to stop (not cut), where each of the images include pixel data indicative a hair area (e.g., hair area 134) of a user.

FIG. 4B illustrates example images 450 (e.g., images 452, 454, and 456) of respective skin areas (e.g., skin areas 452s, 454s, and 456s) of a user in accordance with various embodiments disclosed herein. As shown for FIG. 4B, each of images 452, 454, and 456 depicts hair cutting implement 108 (e.g., a trimmer) next to the user's skin in respective skin areas 452s, 454s, and 456s. Each of the images 452, 454, and 456 comprise pixel data, which may be analyzed for detecting or otherwise identifying skin areas (e.g., 452h, 454h, and 456h) as described for smart personal grooming method 300, or otherwise the algorithm thereof, for FIG. 3A or elsewhere herein. Further, the pixel data of images 452, 454, and 456 may be used for training the learning model as described herein, including for training the learning model to classify the images 452, 454, and 456 as region to cut, where each of the images include pixel data indicative a skin area (e.g., skin area 132) of a user, and where the skin area may include hair stubble to trim or cut.

FIG. 5A illustrates an image 500 depicting an edge or a boundary 501 defined between a skin area 132 and a hair area 134 of a user. FIG. 5A further depicts a plurality of regions of interest (ROIs) or patches (e.g., patches 502, 504, 506, 508, and 510) and related patch-based classifications (e.g., patch-based classifications having values of 0.81, 0.48, 0.28, 0.22, and 0.37, respectively) of image 500 in accordance with various embodiments disclosed herein. As shown for FIG. 5A, hair cutting implement 108 is positioned on the user's skin area 132. Opposite of the hair cutting implement 108, image 500 depicts the user's hair area 134. Image 500 also depicts several patches (e.g., patches 502, 504, 506, 508, and 510) each having an assigned or otherwise detected classification and related classification value. The patches may each comprise a certain pixel height and width (e.g., 32 pixels by 32 pixels) within image 500. In some implementations, each patch may comprise a length and/or width corresponding to (such as equal to, or slightly larger than) a length and/or width the hair cutting implement (e.g., a trimmer blade) or portion thereof, as shown for FIG. 5A. For example, in some implementations, each patch may comprise an image region having a width of 160 pixels and a height of 32 pixels (e.g., which could cover an area or portion of hair cutting implement 108). Still further, in some implementations, the patches may be superimposed on an image (e.g., image 500). In other implementations, the patches may not be superimposed, but instead determined by processor 122.

With further reference to FIG. 5A, patch 502 comprises a pixel area that has an assigned or detected classification, e.g., a region to cut classification (Region to Cut). The classification may be based on patch 502's related classification value of 0.81, which may indicate a probability (e.g., an 81% chance) that pixels detected within patch 502 of image 500 have been detected as below a given hair classification value. That is, the patch-based classification value of 0.81 indicates that patch 502 has hair, as detected within the pixels of patch 502, as being below a given hair length threshold as set for the smart personal grooming device 100, e.g., to control smart personal grooming device 100 to cut or trim hair stubble of the user.

Similarly, each of patches 504, 506, 508, and 510 comprises a pixel area that has an assigned or detected classification, e.g., a region to stop classification (Region to Stop). The classification may be based on each of the patch's related classification values (e.g., 0.48, 0.28, 0.22, and 0.37, respectively), which may indicate respective probabilities (e.g., 48% chance, 28% chance, 22% chance, and 37% chance, respectively) that pixels detected within the related patches (504, 506, 508, and 510, respectively) of image 500 have been detected as below a given hair classification value. That is, the patch-based classification values (e.g., 0.48, 0.28, 0.22, and 0.37, respectively) indicates that the related patches (504, 506, 508, and 510, respectively) has hair, as detected within the respective pixels, as being below a given hair length threshold value as set for the smart personal grooming device 100. Because the probabilities are low, then each of the patch-based classifications for patches 504, 506, 508, and 510 are determined as a region to stop classification (Region to Stop), e.g., to control smart personal grooming device 100 to not cut the longer hair (e.g., a bear) of the user.

While the probabilities in the above example suggest that higher probabilities (e.g., above 50%) indicate a region to cut classification, and that lower probabilities (e.g., below 50%) indicate a region to stop classification, it should be understood that different probabilities may be used. For example, the probability thresholds for determination or detection of region to stop or region to cut could be changed to any value on a percentage scale, where, for example, a higher percentage (or lower percentage as the case may be) may cause one classification or the other to be assigned or detected more frequently (or not). Still further, the probabilities may be reversed, where a higher probably (e.g., above 50%) suggests that a region to cut classification is assigned or detected, and vice versa with respect to a lower probability.

With further reference to FIG. 5A, a plurality of patches (e.g., patches 502, 504, 506, 508, and 510) may define a boundary, e.g., boundary 501. The boundary may be classified or detected as an edge between skin area 132 and hair area 134. The detection of the boundary may cause the edge of a given patch, or otherwise portion of a given patch, to be assigned or detected as an edge region classification (an Edge Region). The edge region classification (i.e., Edge Region) may define an edge of a beard or other hairstyle, such as a line or shaping of a user's hair.

In various implementations, processor 122 may determine, detect, or create patches with respect to a given image as capture by camera 110. For example, computing instructions (e.g., as stored on memory 124 of smart personal grooming device 100) are configured, when executed, to cause the processor 122 to subdivide into a plurality of regions of interest or patches (e.g., patches 502, 504, 506, 508, and 510) an image (e.g., image 500) depicting the skin area (e.g., skin area 132) of the user and the hair area (e.g., hair area 134) of the user as captured by the camera (e.g., camera 110). Processor 122 may then assign a patch-based classification (e.g., a region to cut classification, a region to stop classification, or an edge classification) to each patch of the plurality of patches based on pixel analysis of each of the plurality of patches. The control state of smart personal grooming device 100 may then be determined, by processor 122, based on each patch-based classification.

In some embodiments, the processor 122 may select the plurality of patches 502, 504, 506, 508, 510 within the image 500 such that the camera 110 is more capable of detecting the transition or boundary 501 between the skin area 132 and the hair area 134. As appreciated by those skilled in the art, the smart personal grooming device 100 may have a certain reaction time between when an image 500 is captured with the boundary 501 and the deactivation of the hair cutting implement 108 based on the identified boundary 501 in the image 500. In one example embodiment, this reaction time may be about 0.25 seconds. It was recognized that various operational parameters of the smart personal grooming device 100 may affect whether or not the smart personal grooming device 100 can identify the boundary 501 and deactivate the hair cutting implement 108 within this reaction time. For example, if the smart personal grooming device 100 is moving at a very high speed along the skin of the user, the hair cutting implement 108 may undesirably reach the boundary 501 from the skin area 132 to the hair area 134 prior to the hair cutting implement 108 being deactivated. Thus, in some embodiments, the smart personal grooming device 100 may be provided with the speed sensor 130 (FIG. 1) which measures a magnitude and direction of speed of the hair cutting implement 108 along the surface (e.g. skin area 132, hair area 134) of the user. The speed sensor 130 may transmit this data to the processor 122. Upon receiving the speed sensor data from the speed sensor 130, the processor 122 may compare the magnitude of the speed with a speed threshold and/or compare the direction of the speed with a direction threshold. The processor 122 may then select the plurality of patches 502, 504, 506, 508, 510 within the image 500 based on this comparison, so that sufficient time is provided between capture of the image data in the patch 502, 504, 506, 508, 510 and deactivation of the hair cutting implement 108 (if necessary) prior to the hair cutting implement 108 reaching the transitoin. Some examples will now be discussed.

One advantage of utilizing the speed sensor to dynamically select the patches 502, 504, 506, 508, 510 within the image 500 may be that instead of using the complete image 500, only part of the image 500 is processed to analyze the surface and detect the presence of the edge or boundary 501 on the surface. Analysis of only a small part of image may improve the efficiency of the device and reduce the computational cost associated with the processing of the whole image. Based on the detection of speed and direction of the user movement using this speed sensor, the patches 502, 504, 506, 508, 510 can be dynamically adjusted in the image to an optimal location and improve detection accuracy. The adjustment of the patches may be done using the feedback of device speed as shown in the following examples.

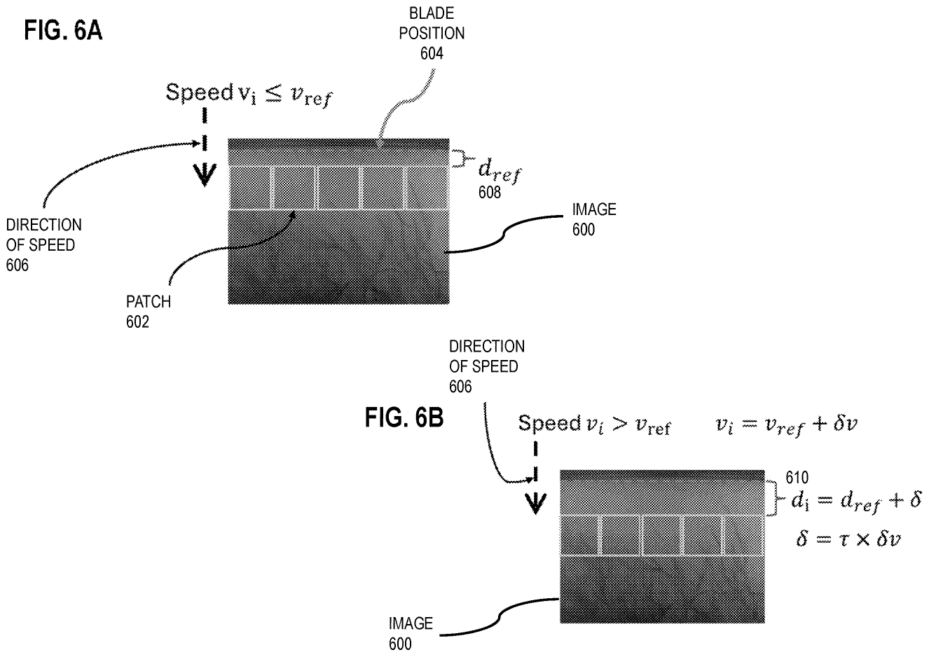

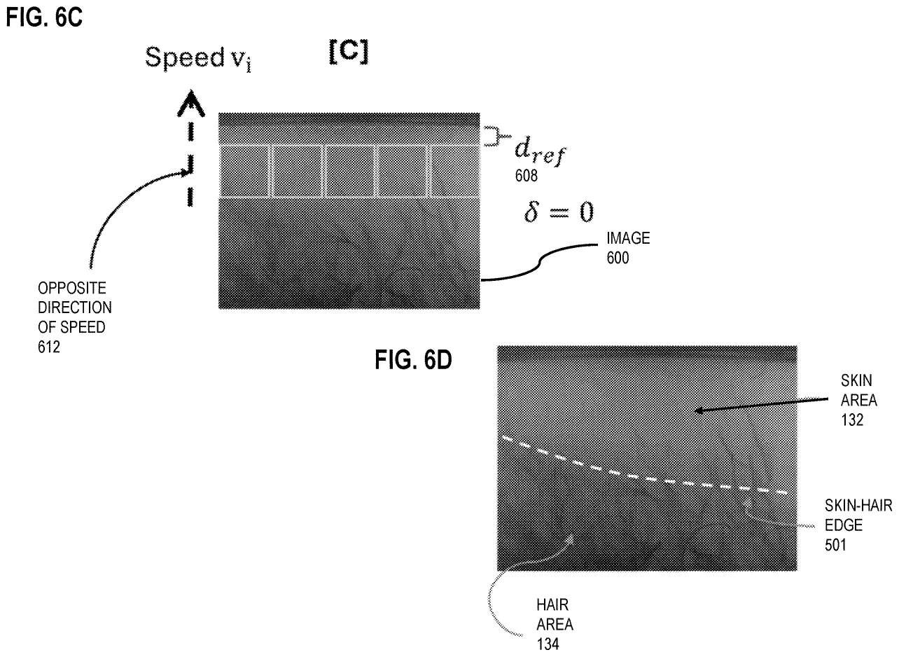

FIG. 6A depicts an image 600 captured by the camera 110 that is similar to the image 500 of FIG. 5A. The blade position 604 is shown that indicates a position of the hair cutting implement 108 in the image 600. For purposes of this disclosure, a “first portion” of the image 600 may reference a portion of the image 600 that is proximate to the hair cutting implement 108 whereas a “second portion” of the image 600 may reference a portion of the image 600 that is distal from the hair cutting implement 108. A direction 606 of speed of the hair cutting implement 108 along the skin area 132 of the user is also depicted. The speed sensor 130 may measure a magnitude of the speed (vi in FIG. 6A) and the direction 606 of the speed. The speed sensor 130 may transmit this data to the processor 122. In one example the direction 606 is defined based on a direction of movement of the hair cutting implement 608 toward the field of view of the camera 110 and/or IR light sources 114. The processor 122 may compare the magnitude of the speed (vi in FIG. 6A) with a speed threshold (v_{ref} in FIG. 6A) that may be stored in the memory 124. In one example, the speed threshold (v_{ref}) may be about 10 mm/sec. Since the measured speed is less than the speed threshold, the processor 122 may position the patches 602 to be spaced apart from the blade position 604 by a reference distance 608 (d_{ref} in FIG. 6A) that may also be stored in the memory 124. In one example, the reference distance 608 (d_{ref}) is about 2.5 mm. The reference distance 608 may be calibrated such that the transit time of the hair cutting implement 108 (with a speed magnitude less than or equal to the speed threshold (v_{ref})) from the blade position 604 to the patches 602 is greater than or equal to the response time (e.g. about 0.25 seconds) of the smart personal grooming device 100. Thus, this spacing of the patches 602 at the reference distance 608 from the blade position 604 advantageously ensures that the boundary 501 may be detected (within the patches 602) and the hair cutting implement 108 may be deactivated prior to the boundary 501 reaching the blade position 604. Otherwise, if the boundary 501 reaches the blade position 604 prior to deactivating the hair cutting implement 108, the hair cutting implement 108 may undesirably cut hair at the boundary 501 and negatively affect the desired edge or boundary 501 (e.g. desired beard edge) of the user. In one example, a scale factor to convert the distance in millimeters to pixels may be about 6.4, and thus in this example where the reference distance d_{ref} is about 2.5 mm, this may correspond with about 16 pixels.

FIG. 6B depicts an image 600 captured by the camera 110 that is similar to the image 500 of FIG. 5A. The blade position 604 is shown that indicates the position of the hair cutting implement 108 in the image 600. A direction 606 of speed of the hair cutting implement 108 along the skin area 132 of the user is also depicted. The speed sensor 130 may measure a magnitude of the speed (vi in FIG. 6B) and the direction 606 of the speed. The speed sensor 130 may transmit this data to the processor 122. The processor 122 may compare the magnitude of the speed (vi in FIG. 6B) with the speed threshold (v_{ref} in FIG. 6B). Since the measured speed is greater than the speed threshold, the processor 122 may position the patches 602 at a distance 610 (di in FIG. 6B) which is greater than the reference distance 608 (d_{ref}) of FIG. 6A. The distance 610 may be calibrated such that the transit time of the hair cutting implement 108 (with a speed magnitude vi in FIG. 6B exceeding the reference velocity v_{ref}) from the blade position 604 to the patches 602 is greater than or equal to the response time (e.g. about 0.25 seconds) of the smart personal grooming device 100. Thus, this spacing of the patches 602 at the distance 610 from the blade position 604 advantageously ensures that the boundary 501 may be detected (within the patches 602) and the hair cutting implement 108 may be deactivated prior to the boundary 501 reaching the blade position 604. Otherwise, if the boundary 501 reaches the blade position 604 prior to deactivating the hair cutting implement 108, the hair cutting implement 108 may undesirably cut hair at the boundary 501 and negatively affect the desired edge or boundary 501 (e.g. desired beard edge) of the user.

In an example embodiment, where the processor 122 moves the patches 602 to be spaced apart by the increased distance 610, this increased distance 610 may be a certain distance (δ) beyond the reference distance 608. Additionally, the increased speed magnitude (vi of FIG. 6B) may exceed the reference speed v_{ref} by a certain speed (δv), such as 1 mm/sec. A parameterized relation of the patch 602 movement distance (δ) with respect to the change in speed (δv) may be:

$$δ = τ \times δ v \qquad ( 1 )$$

As a result, the detection of hair-skin edge or transition 501 may happen at distance:

$${d}_{i} = {d}_{r e f} + δ = {d}_{r e f} + δ v \times τ = 2.5 mm + 1 mm / sec \times 0.25 sec = 2.75 mm \qquad ( 2 )$$

The device 100 may now look further ahead and be capable of reacting to the detection of the transition earlier.

This increase in the distance of the patches 602 from the cutting implement 108 may enable accurate edging even at higher than nominal shave stroke speed. Without this automatic patch adjustment based on the feedback from the speed sensor 130, the device latency (e.g., between skin-hair edge detection and the processor reaction to stop the cutting implement after this detection) may lead to inaccurate edging and the device may undesirably cut into the beard edge. The device 100 may have a linear relationship between δ and δv. One variation may include non-linear case of this relationship where δ=f(δv) where f(⋅) may be a non-linear function.

In yet another embodiment, a variation of this method may include introduction of a delay instead of movement of the patch 602. For example, if the device 100 moves faster than the nominal shave stroke speed, the delay of stopping the cutting implement could be reduced and the device may still stop comparatively faster. If the detected speed of shave is slower than the nominal value, then this delay of stopping the cutting action may increase and the device may react slower. This variation may also enable a similar response to variable shaving speeds of users.

FIG. 6C depicts an image 600 captured by the camera 110 that is similar to the image 500 of FIG. 5A. The blade position 604 is shown that indicates the position of the hair cutting implement 108 in the image 600. A direction 612 of speed of the hair cutting implement 108 along the skin area 132 of the user is depicted. It should be noted that the direction 612 is opposite from the direction 606 of the speed in FIGS. 6A and 6B and indicates a direction of movement of the hair cutting implement 108 away from a field of view of the camera 110 and/or IR light sources 114. The speed sensor 130 may measure a magnitude of the speed (vi in FIG. 6C) and the direction 612 of the speed. The speed sensor 130 may transmit this data to the processor 122. The processor 122 may compare the direction 612 of the speed with a speed direction threshold (e.g. direction 606) that is a direction of the hair cutting implement 108 towards a field of view of the camera 110 and/or IR light sources 114. Since the measured direction 612 is not the speed direction threshold (e.g. direction 606), the processor 122 may position the patches 602 to be spaced apart from the blade position 604 by the reference distance 608 (d_{ref} in FIG. 6C). Since the hair cutting implement 108 is not moving in the direction 606 (e.g., towards the boundary 501), there may be no need to space the patches 602 from the blade position 604 by greater than the reference distance 608.

FIG. 6D depicts an image including a skin-hair edge or boundary 501 between the skin area 132 and the hair area 134.

In various implementations, the learning model (as described herein) outputs the patch-based classification(s) to determine the control state of the smart personal grooming device 100. In some implementations, pixel data of one or more images (e.g., image 500) may be used for training learning model or for inputting into an already trained learning model to implement the algorithm or otherwise method of FIG. 3A or elsewhere as described herein. For example, image 500 comprises example pixel data of skin area 132 (depicting skin and stubble features), hair area 134 (e.g., having long hair features), and hair cutting implement 108 (e.g., comprising mechanical or metallic features) that may be used for training and/or implementing a learning model (e.g., learning model), in accordance with various embodiments disclosed herein. For example, hair area 134, which includes patches 504, 506, 508, and 510, comprises long hair that depicts darker pixels (e.g., pixels with low R, G, and B values) or pixels shaped in linear, curly, consecutive, string-like, or hair-shaped pattern. Skin area 132 may depict spotty or randomized patches of different colored pixels, when compared to the broader color region of the user skin, thereby representative of hair stubble on the user's skin. Still further, hair cutting implement 108 may comprise brighter pixel colors (e.g., a pixels with high R, G, and B values) indicating metal or mechanical features of hair cutting implement 108. Such pixel data may be used to determine the boundary within image 500 and/or make classification for the various patches image 500 for controlling smart personal grooming device 100.

Additionally, or alternatively, an algorithm to determine a control of the smart personal grooming device 100 may be implemented with computing instructions (e.g., non-AI computing instructions), that may comprise if-then-else logic based on, e.g., physical parameters of hair edges, hair color, skin color, length of hair, shape of hair (e.g., curliness of hair) as identified by one or more pixel(s) of the patches. That is, a procedural (non-AI) method (if-then-else) would focus on pixel intensity of RGB values of the individual pixels as detected when the smart personal grooming device 100 moves from skin-to-hair areas or vice versa of a user. In such implementations, an image (e.g., image 500) may be subdivided into a plurality of patches (e.g., patches 502-510, where each of the one or more images depict the skin area (e.g., skin area 132) of the user and the hair area (e.g., hair area 134) of the user as captured by the camera (e.g., camera 110). Processor 112 is configured to assign a patch-based classification to each patch of the plurality of patches based on whether hair identified within a respective patch is depicted as above the hair length threshold or below the hair length threshold. The control state may then be determined or otherwise based on each patch-based classification.

FIG. 5B illustrates a sequence 550 of images (e.g., 552, 554, 556, 558, and 559) depicting respective boundaries defined between a skin area and a hair area of a user, wherein each image pertains to a plurality of patches (e.g., 552p, 554p, 556p, 558p, and 559p) and related patch-based classifications (e.g., classifications regarding cutting, stopping, or edge detected) in accordance with various embodiments disclosed herein. Sequence 550 may represent a series of images (e.g., a video of image frames) as captured by camera 110. The series of images may be analyzed or otherwise processed as described herein, for example, by smart personal grooming method 300 as described herein for FIG. 3A. The sequence 550 of image depicts hair cutting implement 108 of smart personal grooming device 100 (the AutoEdger) moving from a skin area (e.g., skin area 132) of the user towards a hair area (e.g., hair area 134) of the user at different points of time t₁ to t₅. That is, image 552 shows hair cutting implement 108 at t₁, image 554 shows hair cutting implement 108 at t₂, image 556 shows hair cutting implement 108 at t₃, image 558 shows hair cutting implement 108 at t₄, and image 559 shows hair cutting implement 108 at t₅. When a boundary is detected (e.g., in image 554), the patch-based classification changes from a region to cut classification (e.g., as shown for image 554 with patches 552p having above 50% values with respect to the hair length threshold value) to a region to stop classification (e.g., as shown for image 554 with one patch below a 50% value with respect to the hair length threshold value). Later-in-time images (images 556, 558, and 559) have further patches classified, based on pixel analysis, as regions to stop classifications. Each of the remaining images (images 556, 558, and 559) have an increasing number of patches having classification values of less than 50% with respect to the hair length threshold value, thus indicating an increased number of patches with a region to stop classification as hair cutting implement 108 moves toward the hair area (e.g., a beard) of the user across time (e.g., t₂ to t₅). Thus, when a patch is classified as a region to stop classification, processor 122 signals the motor of smart personal grooming device 100 to stop, which prevents the cutting or trimming action of hair cutting implement 108.

In a more detailed example, and with reference to FIG. 5B, a learning model (such as a neutral network) is deployed on smart personal grooming device 100, for example, by storing the learning model in memory 124. The model may be deployed and/or stored to smart personal grooming device 100 and trained with images showing skin areas and hair areas, as described and depicted herein. In one implementation, the computing instructions, as executed by processor 122, cause camera 110 of smart personal grooming device 100 to capture images (e.g., video), such as the image shown in sequence 550. In some implementations, the images may be cropped or reduced in size. For example, the images may be cropped to a width of 160 pixels and a height of 32 pixels. In some implementations, the cropped image may be further subdivided into patches (e.g., patches 502, 504, 506, 508, and 510; or patches as shown in plurality of patches or otherwise patch groups 552p, 554p, 556p, 558p, and 559p), where each patch has with a width of 32 pixels and a height of 32 pixels. As described herein, however, other pixel heights and widths may be used.

In the example implementation, the learning model classifies each patch as one of a region to cut classification, a region to stop classification, and an edge region classification. When the user moves the smart personal grooming device 100 (and thus hair cutting implement 108) from the skin area towards the hair area, if at least one patch is detected as a region to stop classification at the predefined edge (e.g., boundary) between the hair (e.g., a beard) and skin, then processor 122 signals the motor of smart personal grooming device 100 to stop, and the trimmer actuator and/or the trimmer blade stops its cutting or trimming action. Otherwise, processor 122 signals the motor to operate, and the actuator and/or the trimmer blade performs a cutting or trimming action to remove hair stubble. The classifications (e.g., region to cut classification, region to stop classification, and an edge region classification) are each based on a hair length threshold value, which may be a setting stored in memory 124. For example, based on a probability output by the learning model, the computing instructions executing on processor 122 determines the probability of a given patch being classified as a region to cut based on the hair length threshold value. If this probability value is greater than a set threshold (e.g., above 50%), then the processor 122 signals the motor to operate, causing the trimmer blade to cut or trim stubble. Otherwise, the processor 122 signals the motor to stop, and no cutting or trimming action occurs.

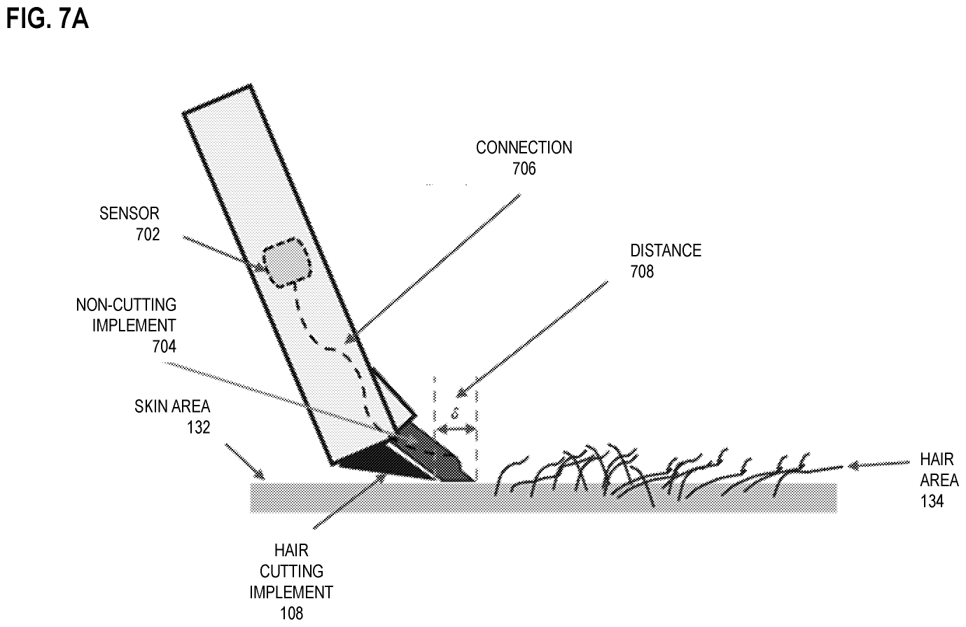

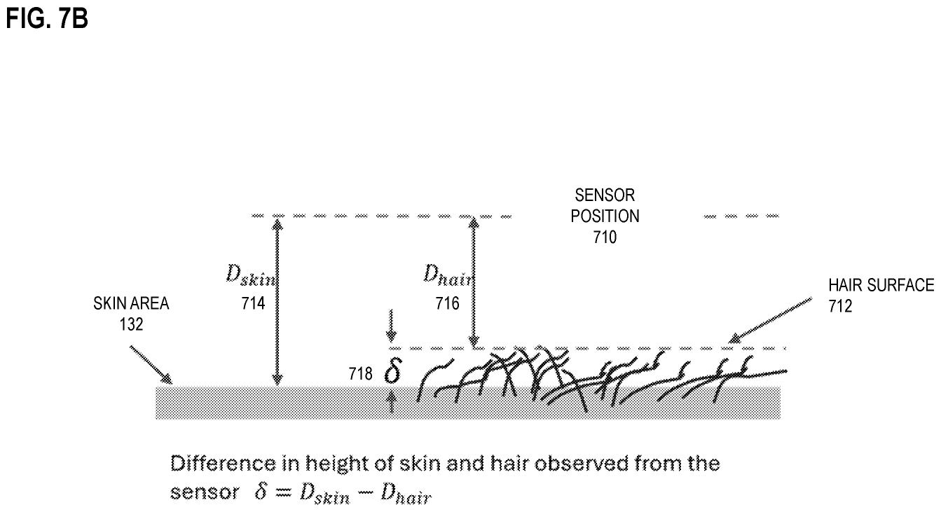

In other embodiments, the sensors employed in the smart personal grooming device 100 are not limited to the previously discussed sensors herein. In yet another embodiment, one or more of an impedance sensor, IMU sensor, Piezo Vibration sensor, Acoustic sensor, Motor load sensor, and/or temperature sensor may be used along with the camera 110 to detect the boundary 501 or edge of the skin area 132 and hair area 134. These sensors may be used in configurations that could be a derivative of the image shown in FIG. 7A herein. In this example embodiment, as shown in FIG. 7A, the smart personal grooming device 100 may include a sensor 702 and a non-cutting implement 704 on the device 100 that may enable looking ahead while the cutting implement 108 is behind the non-cutting implement 704 when the device 100 is moving toward the beard edge or transition 501. A connection 706 may be provided between the sensor 702 and the non-cutting implement 704. The non-cutting implement 704 may be spaced forward from the hair cutting implement 108 by a distance 708. The sensor 702 may also be communicatively coupled with the processor 122 of the device 100 and thus may transmit sensor data to the processor 122 such that the processor 122 may process this sensor data when determining whether to turn the hair cutting implement 108 off (e.g. when detecting the boundary 501 or skin-hair edge).

In one example embodiment, the sensor 702 of FIG. 7A may be an impedance sensor. In this example embodiment, the non-cutting implement 704 may enable measuring the skin area 132 and hair area 134 impedance. As appreciated by one skilled in the art, skin has a lower impedance than hair. If the non-cutting implement 704 detects this change of impedance while the device 100 is moving towards the hair area 134, the non-cutting implement 704 may signal the processor 122 to stop the cutting action of cutting implement 108 before the hair cutting implement 108 reaches the boundary 501 or skin-hair edge.

In another example embodiment, the sensor 702 of FIG. 7A may be an IMU sensor. In this example embodiment, the non-cutting implement 704 may change a vibration frequency when it transitions from the skin area 132 to the hair area 134. This change of frequency may be detected using the IMU sensor 702 (e.g., accelerometer component of IMU sensor) which in-turn may be used for detection of the boundary 501 or skin-hair edge.

In another example embodiment, the sensor 702 of FIG. 7A may be a Piezo Vibration sensor. In this example embodiment, the Piezo-vibration sensor 702 may detect the change in vibration of non-cutting implement 704 before the cutting implement 108 reaches the boundary 501 or hair-skin edge. This detection may be realized in a piezo vibration sensor 702 by changes in its conductivity due to change of vibration frequency.

In another example embodiment, the sensor 702 of FIG. 7A may be an acoustic sensor. In this example embodiment, the non-cutting implement 704 may be connected to the motor along with the cutting implement 108. When the non-cutting implement 704 reaches the skin-hair edge or boundary 501, there may be a change in the motor load. As a result of contact of the non-cutting implement 704 with the hair area 134, there may be a change in the sound of the motor. The sound may be used as a signal for detection of the boundary 501 or skin-hair edge.

In another example embodiment, the sensor 702 of FIG. 7A may be a motor load sensor. In, this example, the non-cutting implement 704 may be connected to the motor along with the cutting implement 108. When the non-cutting implement 704 reaches the skin-hair edge, there may be a change in the motor load. The contact of hair with the non-cutting implement 704 may increase the load on the motor. This increased load may result into motor drawing more current for rotation. The increase in current required for motor rotation may be used as a signal for skin-hair edge detection when the device 100 is transitioning from the skin area 132 to the hair are 134.

In another example embodiment, the sensor 702 of FIG. 7A may be a temperature sensor. In this example, the non-cutting implement 704 may be a temperature sensor that detects the change in the temperature as the device 100 transitions from the skin area 132 to the hair area 134 during use. The skin area 132 may have a temperature higher than the hair area 134. This change in temperature may be detected using the sensor 702 for edge detection between the skin area 132 and the hair area 134.

In yet another example embodiment, another commercially relevant modification of the disclosed device 100 may be removing the camera 110 from the device 100 and using one or more of the following sensors as described in the previous section for skin-hair edge detection: impedance sensor, IMU sensor, Piezo Vibration sensor, Acoustic sensor, Motor load sensor, and/or temperature sensor.

In another embodiment, the device 100 may be used for trimming the non-facial hair. In this embodiment, another modification may be the use of such a device 100 to cut beyond the line-of-sight hair such as hair on the neck or back. A design around may also be for a sense and inform purpose, where an optical sensor may be used for sensing the hair area 134 and informing the user about their current styles and suggesting a change in the hair style, for example.

In yet another embodiment, additional modification of the device 100 hardware may include the following configurations. In one example, for the combination of the camera 110 with another sensor working together for edge detection, the other sensor(s) may work with the camera 110 with various configurations. In a first configuration, the additional sensor(s) may include but is not limited to the contact sensor 128 (e.g. resistive touch sensor or optical touch sensor) for sensing the contact between the device 100 (e.g. hair cutting implement 108) and the surface of the user (e.g. skin area 132 or hair area 134). In a second configuration, the additional sensor(s) may include an IMU sensor to detect a speed and direction of shave stroke.

In a third configuration, the additional sensor(s) may include a distance sensor. FIG. 7B depicts an image of a distance sensor being used in conjunction with the device 100 herein. In one example embodiment, the distance sensor may include but is not limited to an ultrasound sensor or a time-of-flight sensor. As shown in FIG. 7B, the distance sensor may be positioned at a position 710 that is a certain distance 714 above the surface of the user (e.g. skin area 132). The sensor may be configured to detect the distance 714 between the sensor and the skin area 132 as well as a distance 716 between the hair surface 712 and the sensor. The sensor may then be configured to detect a difference 718 in height between the skin area 132 and the hair surface 712. As depicted in FIG. 7B, this difference 718 may be based on a difference between the distance 714 and the distance 716. Such a distance sensor may work in combination with the camera 110 to detect the boundary 501 or hair-skin edge. The change 718 in the distance between the target surface and the sensor may enable detection of the boundary 501 or hair-skin edges and may be used along with the camera 110 to improve the edge detection.

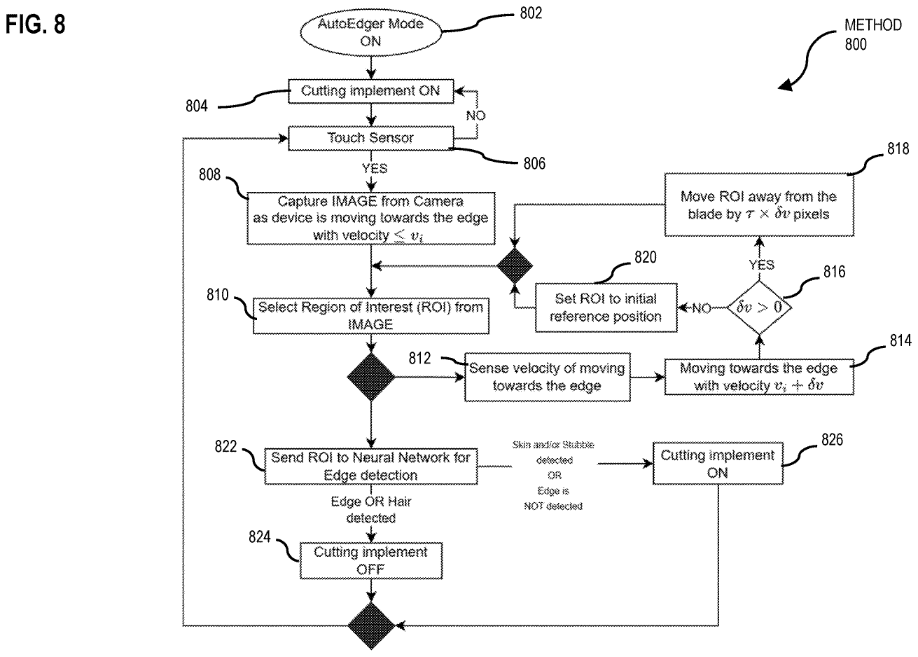

FIG. 8 depicts a flowchart that illustrates one or more steps of a method 800 for operating the smart personal grooming device 100. Although steps are depicted in FIG. 8 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 802, in one embodiment, the smart personal grooming device 100 may be activated. In one example embodiment, in step 802 the AutoEdger mode of the smart personal grooming device 100 may be activated.

In step 804, the hair cutting implement 108 of the smart personal grooming device 100 may be turned on. In one example, in step 804 the processor 122 may transmit a signal to the hair cutting implement 108 to turn on, based on the user turning on the AutoEdger mode in step 802. In still another example, in step 804 the processor 122 may transmit the signal to activate the hair cutting implement 108 based on the processor 122 receiving a signal from the contact sensor 128 indicating contact between the contact sensor 128 (and hair cutting implement 108) and the skin area 132 of the user.

In step 806, the processor 122 may determine whether the contact sensor data from the contact sensor 128 indicates contact between the contact sensor 128 (and hair cutting implement 108) and the skin area 132 of the user. If this determination is in the affirmative, the method 800 may move to block 808, otherwise the method 800 may move back to block 804.

In step 808, the camera 110 may capture one or more images of the skin area 132 and hair area 134 of the user. In one example, in step 808 the camera may capture the one or more images, as the device 100 moves along the surface of the user (e.g. skin area 132) with a certain speed and direction.

In step 810, the processor 122 may receive the image data from the camera 110 and may select one or more regions of interest or patches from the image. In one example, in step 810 the processor 122 may select the one or more patches from the image, based on the reference distance d_{ref} previously discussed with respect to FIGS. 6A through 6D.

Steps 812 through 820 will now be discussed, which may be used to dynamically adjust the initial one or more patches selected in step 810, so to optimize the performance of the device 100 and ensure that the device 100 does not prematurely cut hair at or beyond the boundary 501 or hair-skin edge.

In step 812, the speed sensor 130 may measure the magnitude and direction of the speed of the device 100 along the surface of the user. In step 812, the speed sensor 130 may transmit this speed data to the processor 122.

In step 814, the processor 122 may process the speed sensor data and determine whether the hair cutting implement 108 is moving towards the boundary 501 or hair-skin edge. In step 814, the processor 122 may determine whether the direction of the speed corresponds to the direction 606 of FIGS. 6A and 6B. If this determination is in the affirmative, the method 800 may move to block 816. If this determination is in the negative, the method 800 may move to block 820. In this example, a negative determination may indicate that the hair cutting implement 108 is moving in the opposite direction 612 of FIG. 6C and as previously discussed herein, in this example the patch 602 may be spaced apart from the blade position 604 by the reference distance 608.

In step 816, the processor 122 may determine whether the magnitude of the measured speed exceeds the reference speed (v_{ref}) previously discussed herein. If this determination is in the affirmative, the method 800 may move to block 818. If this determination is in the negative, the method 800 may move to block 820.

In step 818, the processor 122 may move the patches 602 away from the blade position 604. This may be due to the measured magnitude of the speed exceeding the reference speed in step 816. In one example, as previously discussed in FIG. 6B, in step 818 the processor 122 may move the patches 602 away from the blade position 604 to an increased distance (di) 610. As previously discussed, this increase in the distance 610 may advantageously ensure that the device 100 can respond to detection of the boundary 501 within the patches 602 such that the hair cutting implement 108 can be deactivated without undesirably cutting hair beyond the boundary 501.

In step 820, the processor may set the patches 602 at a distance away from the blade position 604 that is the reference distance 608 (dref). This may be based on the determination in block 816 that the magnitude of the speed is not greater than the reference speed. As previously discussed, this setting the distance between the patches 602 and the blade position 604 to be the reference distance 608 may also advantageously ensure that the device 100 can respond to detection of the boundary 501 within the patches 602 such that the hair cutting implement 108 can be deactivated without undesirably cutting hair beyond the boundary 501.

In step 822, the one or more regions of interest (ROI) or patches 602 are sent to the neutral network for edge detection. In this example, in step 822 the neural network or learning model may determine whether the boundary 501 is detected within the ROIs or patches 602 of the image.

In other embodiments, the contact sensor 128 may be used to detect the boundary 501 rather than the camera 110. In these embodiments, steps 808 through 818 may be omitted and the method 800 may move from step 806 to step 822 where the processor 122 may process the contact sensor data to detect the boundary 501 or hair-skin edge.

In step 824, upon detecting the boundary 501, the processor 122 may transmit a signal to deactivate the hair cutting implement 108. In one embodiment, the boundary 501 may be detected in the ROIs or patches 602 of the image. In other embodiments, the boundary 501 may be detected based on processing the contact sensor data. This may be done to ensure that the hair cutting implement 108 does not cut hair at or beyond the boundary 501 or skin-hair, so the user can maintain a desired hair style or shape (e.g. beard shape).

As discussed with respect to step 806, it is contemplated that the contact sensor 128 may be utilized to power on the smart personal grooming device 100 automatically upon the detection of the contact sensor 128 to either skin and/or hair area. Such configurations can save on energy usage as the smart personal grooming device 100 would only turn on when in use. In addition to or independently of the foregoing, a timer may be coupled to a processor 122 and de-energize the smart personal grooming device 100 after a pre-determined period of time (e.g. 1-3 minutes) in the absence of a signal from the contact sensor 128 that the smart personal grooming device 100 is in use.

### Combinations

A first aspect may include a smart personal grooming device comprising: a body comprising a handle; a head portion connected to the body and a hair cutting implement; a camera oriented toward the hair cutting implement and configured to capture one or more images of a skin area and a hair area of a user when operating the smart personal grooming device, each of the images having a first portion proximal to the hair cutting implement and a second portion distal from the hair cutting implement; a sensor configured to measure sensor data based on movement of the smart personal grooming device; a processor communicatively coupled to the camera and the sensor; and a memory communicatively coupled to the processor and storing computing instructions that, when executed by the processor, causes the processor to: capture, by the camera, one or more images depicting the skin area of the user and the hair area of the user, detect, based on one or more images, each of the skin area and the hair area, wherein a boundary is defined between the skin area and the hair area; and determine a control state based on the boundary as detected in the one or more images, wherein the control state causes the computing instructions to execute the processor to implement at least one of: (a) activate the hair cutting implement to cause the hair cutting implement to remove hair in the hair area of the user; (b) deactivate the hair cutting implement; (c) activate of a haptic vibrator of the smart personal grooming device; (d) activate an audio device of the smart personal grooming device; (e) initiate a visual indicator of the smart personal grooming device; or (f) changing a cutting speed of the hair cutting implement, and wherein the smart personal grooming device comprises an infrared light source oriented toward the hair cutting implement and configured to illuminate the skin area and hair area of a user when operating the smart personal grooming device.

Another aspect which may include the first aspect wherein the smart personal grooming device further comprising a second infrared light source oriented toward the hair cutting implement and configured to illuminate the skin area and hair area of a user when operating the smart personal grooming device.

Another aspect which may include any of the previous aspects, wherein the hair cutting implement comprises a rotary shaver.

Another aspect which may include any of the previous aspects, wherein the hair cutting implement comprises a foil and an undercutter.

Another aspect which may include any of the previous aspects, wherein the hair cutting implement comprises a reciprocating blade.

Another aspect which may include any of the previous aspects, further comprising a contact sensor associated with the cutting implement such that the contact sensor is in contact with a skin area of a user, when operating the smart personal grooming device, and wherein the contact sensor is communicatively coupled with the processor.

A second aspect may comprise a smart personal grooming method comprising: capturing, by a camera, one or more images depicting a skin area of a user and a hair area of the user, wherein the camera is positioned relative to a body comprising a handle, wherein a head portion is connected to the body and a hair cutting implement, and wherein the camera is oriented toward the hair cutting implement and configured to capture images of the skin area and the hair area of the user when the user uses the hair cutting implement to cut or trim hair, measuring, with a sensor, sensor data based on movement of the smart personal grooming device; detecting by a processor communicatively coupled to the camera and the sensor, and based on the sensor data and the one or more images, each of the skin area and the hair area, wherein a boundary is defined between the skin area and the hair area; determining, by the processor, a control state based on the boundary as detected in the one or more images; and implementing, by the processor based on the control state, at least one of: (a) activating the hair cutting implement to cause the hair cutting implement to remove hair in the hair area of the user; (b) deactivating the hair cutting implement; (c) activating of a haptic vibrator; (d) activating an audio device; (e) initiating a visual indicator; or (f) changing a cutting speed of the hair cutting implement.

Another aspect which may include the second aspect, wherein the sensor is a speed sensor that is configured to measure the sensor data, wherein the processor is configured to determine a speed and a direction of the smart personal grooming device based on the sensor data received from the speed sensor and wherein the processor is configured to detect each of the skin area and the hair area based on the speed and direction of the smart personal grooming device.

Another aspect which may include any of the previous aspects, further comprising: outputting, by a learning model, at least one classification based on whether a probability of an image of a plurality of images having an image characteristic is above or below a probability threshold, wherein the learning model is stored in a memory and trained with the plurality of images of users when operating the smart personal grooming device, and wherein the control state is based on the at least one classification.

A third aspect may include a tangible, non-transitory computer-readable medium storing instructions for a smart personal grooming device, that when executed by a processor the smart personal grooming device, causes the processor to: capture, by a camera, one or more images depicting a skin area of a user and a hair area of the user, wherein the camera is positioned relative to a body comprising a handle, wherein a head portion is connected to the body and a hair cutting implement, and wherein the camera is oriented toward the hair cutting implement and configured to capture images of the skin area and the hair area of the user when the user uses the hair cutting implement to cut or trim hair; measuring, with a sensor, sensor data based on movement of the smart personal grooming device; detect by the processor communicatively coupled to the camera and the sensor, and based on the sensor data and the one or more images, each of the skin area and the hair area, wherein a boundary is defined between the skin area and the hair area; determine, by the processor, a control state based on the boundary as detected in the one or more images; and implement, by the processor based on the control state, at least one of: (a) activate the hair cutting implement to cause the hair cutting implement to remove hair in the hair area of the user; (b) deactivate the hair cutting implement; (c) activate a haptic vibrator of the smart personal grooming device; (d) activate an audio device of the smart personal grooming device; (e) initiating a visual indicator of the smart personal grooming device; or (f) changing a cutting speed of the hair cutting implement.

A fourth aspect may include a smart personal grooming device comprising: a body comprising a handle; a head portion connected to the body and a hair cutting implement; a contact sensor associated with the cutting implement such that the contact sensor is in contact with a skin area of a user when operating the smart personal grooming device; a processor communicatively coupled to the contact sensor; and a memory communicatively coupled to the processor and storing computing instructions that, when executed by the processor, causes the processor to: determine, by the contact sensor a presence of the skin area of the user and subsequently determine by the contact sensor, a presence of a hair area of the user, detect, based on data from the contact sensor, a boundary between the skin area and the hair area; and determine a control state based on the boundary as detected via the contact sensor, wherein the control state causes the computing instructions to execute the processor to implement at least one of: (a) activate the hair cutting implement to cause the hair cutting implement to remove hair in the hair area of the user; (b) deactivate the hair cutting implement; (c) activate of a haptic vibrator of the smart personal grooming device; (d) activate an audio device of the smart personal grooming device; (e) initiate a visual indicator of the smart personal grooming device; or (f) changing a cutting speed of the hair cutting implement.

Another aspect which may include any of the previous aspects, wherein the contact sensor is a resistance sensor and wherein the resistance sensor provides one or more resistance values to the processor.

Another aspect which may include any of the previous aspects, wherein the contact sensor is a capacitance sensor, and wherein the capacitance sensor provides one or more capacitance values to the processor.

Another aspect which may include any of the previous aspects, further comprising: a learning model stored in the memory and trained with a plurality of values relating to resistance of skin area and resistance of hair area of users when operating the smart personal grooming device.

Another aspect which may include any of the previous aspects, wherein a learning model stored in the memory and trained with a plurality of values relating to capacitance of skin area and resistance of hair area of users when operating the smart personal grooming device.

Another aspect which may include any of the previous aspects, wherein the learning model is configured to output at least one classification based on comparison of the one or more resistance values or one or more capacitance values to a threshold value, and wherein the control state is based on the at least one classification.

Another aspect which may include any of the previous aspects, wherein the at least one classification comprises one or more of: (a) a region to cut classification; (b) a region to stop classification; or (c) an edge region classification.

Another aspect which may include any of the previous aspects, wherein the learning model is a neural network-based model.

Another aspect which may include any of the previous aspects, wherein the at least one classification is based on one or more features identifiable with the one or more images, the one or more features comprising: hair color, hair pixel intensity, hair length, hair shape, skin color, skin tone, or skin texture.

Another aspect which may include any of the previous aspects, wherein the dimensions of the contact sensor are less than 4 cm in width and 4 cm in length.

Another aspect which may include any of the previous aspects, wherein the contact sensor has a width that is within 10 percent of a width of the hair cutting implement.

Another aspect which may include any of the previous aspects, further comprising a camera oriented toward the hair cutting implement and configured to capture images of the skin area and the hair area of a user when operating the smart personal grooming device, and wherein the processor is communicatively coupled to the camera.

Another aspect which may include any of the previous aspects, wherein the processor captures, by the camera, one or more images depicting the skin area of the user and the hair area of the user.

Another aspect which may include any of the previous aspects, wherein the processor detects, based on one or more images, each of the skin area and the hair area, wherein a boundary is defined between the skin area and the hair area.

Another aspect which may include any of the previous aspects, wherein the processor determines the control state based upon the boundary as detected in the one or more images,

Another aspect which may include any of the previous aspects, further comprising a learning model stored in the memory and trained with a plurality of images of users when operating the smart personal grooming device, wherein the learning model is configured to output at least one classification based on whether a probability of an image of the plurality of images having an image characteristic is above or below a probability threshold, and wherein the control state is based on the at least one classification.

Another aspect which may include any of the previous aspects, further comprising: subdividing into one or more patches each of the one or more images depicting the skin area of the user and the hair area of the user as captured by the camera, and assigning a patch-based classification to each patch of the one or more patches based on whether a probability of a respective patch having a patch characteristic is above or below a probability threshold, wherein the control state is based on each patch-based classification.

Another aspect which may include any of the previous aspects, wherein each patch comprises an image region having a width of 160 pixels and a height of 32 pixels.

Another aspect which may include any of the previous aspects, further comprising an infrared light source oriented toward the hair cutting implement and configured to illuminate the skin area and hair area of a user when operating the smart personal grooming device.

Another aspect which may include any of the previous aspects, further comprising a second infrared light source oriented toward the hair cutting implement and configured to illuminate the skin area and hair area of a user when operating the smart personal grooming device.

Another aspect which may include any of the previous aspects, wherein the hair cutting implement comprises a rotary shaver.

Another aspect which may include any of the previous aspects, wherein the hair cutting implement comprises a foil and an undercutter.

Another aspect which may include any of the previous aspects, wherein the hair cutting implement comprises a reciprocating blade.

Another aspect which may include any of the previous aspects, further comprising a speed sensor in communication with the processor.

Another aspect which may include any of the previous aspects, wherein the learning model runs only when the contact sensor is touching the skin area and/or the hair area.

Another aspect which may include any of the previous aspects, wherein the camera is spaced a vertical distance of about 2.5 cm from a bottom surface of the contact sensor when the smart personal grooming device is on a flat horizontal surface.

Another aspect which may include any of the previous aspects, wherein the contact sensor has a minimum height of about 1 mm and a minimum width of about 1 mm.

### Additional Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A smart personal grooming device comprising:
a body comprising a handle;
a head portion connected to the body and a hair cutting implement;
a camera oriented toward the hair cutting implement and configured to capture one or more images of a skin area and a hair area of a user when operating the smart personal grooming device, each of the images having a first portion proximal to the hair cutting implement and a second portion distal from the hair cutting implement;
a sensor configured to measure sensor data based on movement of the smart personal grooming device;
a processor communicatively coupled to the camera and the sensor; and
a memory communicatively coupled to the processor and storing computing instructions that, when executed by the processor, causes the processor to:
capture, by the camera, one or more images depicting the skin area of the user and the hair area of the user,
detect, based on one or more images, each of the skin area and the hair area, wherein a boundary is defined between the skin area and the hair area; and
determine a control state based on the boundary as detected in the one or more images,
wherein the control state causes the computing instructions to execute the processor to implement at least one of:
(a) activate the hair cutting implement to cause the hair cutting implement to remove hair in the hair area of the user;
(b) deactivate the hair cutting implement;
(c) activate of a haptic vibrator of the smart personal grooming device;
(d) activate an audio device of the smart personal grooming device;
(e) initiate a visual indicator of the smart personal grooming device; or
(f) changing a cutting speed of the hair cutting implement.

2. The smart personal grooming device of claim 1, wherein the sensor is a motion sensor that is configured to measure the sensor data based on movement of the smart personal grooming device.

3. The smart personal grooming device of claim 2, wherein the motion sensor is a speed sensor that is configured to measure the sensor data and wherein the processor is configured to determine a speed and a direction of the smart personal grooming device based on the sensor data received from the speed sensor.

4. The smart personal grooming device of claim 1 further comprising:
a learning model stored in the memory and trained with a plurality of images of users when operating the smart personal grooming device,
wherein the learning model is configured to output at least one classification based on whether a probability of an image of the plurality of images having an image characteristic is above or below a probability threshold; and
wherein the control state is based on the at least one classification.

5. The smart personal grooming device of claim 4 wherein the one or more images for training the learning model comprise images having height of 10 to 1944 pixels and width of 10 to 2592 pixels.

6. The smart personal grooming device of claim 4, wherein the one or more images for training the learning model comprise images having height of 32 pixels and a width of 32 pixels.

7. The smart personal grooming device of any of claim 4, wherein the one or more images for training the learning model comprise images having at least a width within 10 percent of a width of the hair cutting implement.

8. The smart grooming device of claim 1, wherein the processor analyzes a patch in the one or more images and wherein the processor is configured to determine a speed and a direction of the smart personal grooming device based on the sensor data.

9. The smart grooming device of claim 8, the processor moves the patch in the one or more images either toward the hair cutting implement or away from the hair cutting implement depending on the determined speed.

10. The smart grooming device of claim 9, wherein the patch moves toward the second portion of the one or more images if the determined speed is above a threshold value.

11. The smart grooming device of claim 9, wherein the patch moves toward the first portion of the one or more images if the determined speed is below a threshold value.

12. The smart grooming device of claim 9, wherein the boundary is detected in the patch.

13. The smart personal grooming device of claim 1, further comprising:
a learning model stored in the memory and trained with a plurality of images of users when operating the smart personal grooming device,
wherein the learning model is configured to output at least one classification based on whether a probability of an image of the plurality of images having an image characteristic is above or below a probability threshold, and
wherein the control state is based on the at least one classification.

14. The smart personal grooming device of claim 13, wherein the probability threshold indicates a hair length threshold that comprises: (a) a value of approximately 3.5 millimeters (mm); (b) a value selected between 0.3 mm and 3.5 mm; (c) a value selected between 0.3 millimeters (mm) and 1.5 mm; or (d) a value selected between 0.9 millimeters (mm) and 2.5 mm.

15. The smart personal grooming device of claim 13, wherein the at least one classification comprises one or more of: (a) a region to cut classification; (b) a region to stop classification; or (c) an edge region classification.

16. The smart personal grooming device of claim 13, wherein the learning model is a neural network-based model.

17. The smart personal grooming device of claim 13, wherein the at least one classification is based on one or more features identifiable with the one or more images, the one or more features comprising: hair color, hair pixel intensity, hair length, skin color, skin tone, or skin texture.

18. The smart personal grooming device of claim 1, further comprising:
subdividing into one or more patches each of the one or more images depicting the skin area of the user and the hair area of the user as captured by the camera, and
assigning a patch-based classification to each patch of the one or more patches based on whether a probability of a respective patch having a patch characteristic is above or below a probability threshold,
wherein the control state is based on each patch-based classification.

19. The smart personal grooming device of claim 1, wherein the computing instructions are further configured, when executed, to cause the processor to:
subdivide into one or more patches each of the one or more images depicting the skin area of the user and the hair area of the user as captured by the camera, and
assign a patch-based classification to each patch of the one or more patches based on pixel analysis of each of the one or more patches,
wherein the control state is based on each patch-based classification.

20. The smart personal grooming device of claim 18, wherein each patch comprises an image region having a width of 160 pixels and a height of 32 pixels, preferably 48 pixels.
